(19) United States
(12) Patent Application Publication
(10) Pub. No.: US 2026/0250540 A1
(43) Pub. Date: Aug. 27, 2026

(54) RADIATION CURABLE COMPOSITIONS FOR COATING OPTICAL FIBERS

(71) Applicants: Covestro (Netherlands) B.V., Geleen (NL); Covestro LLC, Pittsburgh, PA (US)

(72) Inventors: Johan Franz Gradus Antonius Jansen, Geleen (NL); Marcel Houben, Echt (NL); Guido Joseph Elisabeth Hensen, Geleen (NL); Huimin Cao, Naperville, IL (US); Meng He, South Elgin, IL (US)

(21) Appl. No.: 18/855,007

(22) PCT Filed: Apr. 19, 2023
(86) PCT No.: PCT/US2023/019085

§ 371 Date: Oct. 8, 2024

Related U.S. Application Data
(60) Provisional application No. 63/333,148, filed on Apr. 21, 2022.
(60) Provisional application No. 63/333,150, filed on Apr. 21, 2022.
(60) Provisional application No. 63/333,151, filed on Apr. 21, 2022.

(51) Int. Cl. C09D 133/14; C08F 20/28; C08F 20/36; C08F 22/22; C09D 5/00; C09D 133/24; C09D 135/02

(52) U.S. Cl. CPC C09D 133/14; C08F 20/28; C08F 20/36; C08F 22/22; C09D 5/00; C09D 133/24; C09D 135/02

(57) ABSTRACT

Disclosed and claimed herein are radiation curable formulations containing a monofunctional telechelic (meth)acrylate oligomer with 0-5 urethane groups and a molecular weight from 750 to 20,000 g/mol; a difunctional or trifunctional telechelic urethane (meth)acrylate oligomer with at least 4 urethane groups and a molecular weight from 750-100,000 g/mol; optionally, a reactive diluent; optionally, a photoinitiator; and optionally, one or more additives comprising an adhesion promoter and/or a stabilized. Also disclosed are methods of using the radiation curable formulations described herein to coat optical fibers, along with the articles produced therefrom.

### TECHNICAL FIELD

The present invention relates generally to radiation curable formulations, especially suitable as optical fiber primary coating compositions, methods of coating optical fibers with the radiation curable formulations as primary coating compositions, and the coated optical fibers produced therefrom.

### CROSS REFERENCE TO RELATED APPLICATIONS

None

### BACKGROUND

Optical fibers are composed of glass fibers obtained by hot melt spinning of glass, and one or more coating layers disposed over the glass fibers for protective reinforcement. Optical fibers are produced, for example, by first forming a flexible primary coating layer on the surface of the glass fibers, and then forming a more rigid secondary covering layer called a secondary coating over the primary coating. Also known are tape-like optical fibers or optical fiber cables having a plurality of optical fibers with a coating layer that are bound with a binding material.

Because they are especially fast-curing and can impart the desired properties onto the optical fiber, radiation curable thermoset compositions have long been used to form the primary and secondary coating layers. Typically, radiation curable optical fiber coatings are the cured product of a composition containing a mixture of one or more components possessing one or more ethylenically unsaturated (C═C) bonds which, under the influence of irradiation, undergo crosslinking by free-radical polymerization. Such composition also typically includes a photoinitiator to assist in the radiation curing, particularly if the curing is effectuated by means of irradiation at ultraviolet (UV) wavelengths.

The relatively soft inner primary coating provides resistance to microbending which results in added attenuation of the signal transmission (i.e. signal loss) of the coated optical fiber and is therefore undesirable. Microbends are microscopic curvatures in the optical fiber involving local axial displacements of a few micrometers and spatial wavelengths of a few millimeters. Microbends can be induced by thermal stresses and/or mechanical lateral forces. Coatings can provide lateral force protection that protect the optical fiber from microbending, but as coating thickness decreases the amount of protection provided decreases.

Primary coatings preferably possess a higher refractive index than the cladding of the associated optical fiber, in order to allow them to strip errant optical signals away from the core of the optical fiber. Primary coatings should maintain adequate adhesion to the glass fiber during thermal and hydrolytic aging, yet (if needed) is capable of being strippable therefrom for splicing purposes. The primary coating typically has a thickness in the range of 20 to 50 μm (e.g., about 25 or 32.5 μm), thinner thickness in the range of 15 to 25 μm for 200 μm fibers.

The harder secondary coating provides resistance to handling forces such as those encountered when the coated optical fiber is ribboned and/or cabled. Radiation curable optical fiber secondary coating compositions also generally comprise a mixture of ethylenically-unsaturated compounds, including one or more acrylate-functional oligomers dissolved or dispersed in liquid ethylenically-unsaturated diluents and photoinitiators. The coating composition is typically applied to the optical fiber in liquid form and then exposed to actinic radiation to effect cure.

The method commonly used to form the covering layer on the glass fibers is, for example, to coat the glass fibers with a liquid curable resin composition and cure it with heat or light, and especially ultraviolet radiation. Fiber optic coatings, including the primary and secondary layers, typically are applied using one of two processes: wet-on-wet (WOW) and wet-on-dry (WOD). In the WOD process, the fiber passes first through a primary coating application, which is cured via exposure to UV radiation. The fiber then passes through a secondary coating application, which is subsequently cured by similar means. In the WOW process, the fiber passes through both the primary and secondary coating applications, whereupon the fiber proceeds to the curing step. In a wet-on-wet process, the curing lamps between primary and secondary coating application are omitted.

There continues to be a drive for more sustainable and effective optical fiber coatings. Known optical fiber coatings which are sufficiently fast-curing, which impart sufficient on-fiber performance, and still sufficiently adhere to their associated optical fiber substrate still possess room for improvement. Specifically, it would be desirable to provide optical fiber primary coatings which maintain an acceptable cure speed and on-fiber performance as has come to be expected by the industry, but nonetheless possess a lower volatility, as evidenced by a reduction in the content of monomeric and/or diluent compounds included therein.

### BRIEF DESCRIPTION OF THE DRAWINGS

None

### BRIEF SUMMARY

Described herein are several aspects and embodiments of the invention. A first aspect is an optical fiber primary coating composition comprising, relative to the weight of the entire primary coating composition: (a) between 70 wt. % to 99 wt. % of one or more oligomers which is the reaction product of (i) a hydroxy- or thiol-functional backbone compound, (ii) an isocyanate compound; and (iii) a hydroxyl-functional end-capper; wherein a molar ratio of the number of isocyanate groups in (ii) to a number of hydroxyl-groups and thiol groups in (i) is less than or equal to 1.0; (b) optionally, one or more urethane (meth)acrylate oligomers other than (a); (c) optionally, one or more reactive diluent monomer; (d) one or more photoinitiator; (e) optionally, one or more additives; wherein if (b) is not present, the one or more oligomer according to (a) possesses at least one ethylenically unsaturated group, preferably at least one or two ethylenically unsaturated groups.

In another embodiment according to the first aspect, the optical fiber primary coating composition is present in even greater amounts than 70 wt. %, such as greater than or equal to 80 wt. %, and less than 96 wt. %. In still other embodiments, the molar ratio of the number of isocyanate groups in (ii) to the number of hydroxyl- and thiol-groups in (i) is less than or equal to ⅔, such that the ratio is between ⅔ (approximately 0.67) to 1.0. In various other embodiments of the first aspect, the one or more oligomers according to (a) possesses a variety of urethane linkages, block structures, theoretical molecular weight values, terminating moieties, backbone types, isocyanate types, and hydroxyl-functional end cap types. In still other embodiments, more specific types with respect to elements (b)-(e) are described.

A second aspect of the current invention is a radiation curable formulation characterized in that the formulation comprises: (a) one or more monofunctional telechelic (meth)acrylate oligomers with 0-5 urethane groups and a molecular weight Mn from 750-20000 g/mol, wherein the one or more monofunctional telechelic (meth)acrylate oligomers according to (a) further comprises a telechelic hydroxyl group; (b) one or more di- or trifunctional telechelic urethane (meth)acrylate oligomers with at least 4 urethane groups and a number average molecular weight (Mn) from 750-100000 g/mol; wherein a molar ratio of (b) to (a) is from 0.01 to 1.5; (c) optionally, one or more reactive diluent with an Mn<500; (d) optionally, a photoinitiator; and (e) optionally, one or more additives comprising an adhesion promoter and/or a stabilizer.

According to various other embodiments of the second aspect of the invention, more specific characteristics, compound genera and/or species, and other qualifying information on the radiation curable formulation is provided. In yet further embodiments of the second aspect, the radiation curable formulation is configured such that, when cured into a film according to the process and dimensions as specified elsewhere herein, it possesses specified values with respect to storage modulus, and time to reach 30% of the storage modulus.

A third aspect of the current invention is a method for coating an optical fiber, comprising providing a glass optical fiber, preferably by drawing a glass optical fiber through a draw tower; applying a primary coating composition onto the surface of the glass optical fiber; optionally, imparting a dose of UV light sufficient to at least partially cure said primary coating composition; applying a secondary coating composition to the primary coating composition; exposing the primary coating composition and the secondary coating composition to at least one radiation source capable of emitting ultraviolet radiation to affect curing of said primary coating composition and said secondary coating composition, to form a cured primary coating on the surface of the optical fiber, and a cured secondary coating on the surface of the cured primary coating; wherein the primary coating composition is a composition according to any of the embodiments of the first aspect or the second aspect of the current invention.

A fourth aspect of the current invention is a coated optical fiber, the coated optical fiber comprising a glass core and a cladding layer in contact with and surrounding said glass core; and a coating portion, said coating portion further including a primary coating layer in contact with and surrounding said cladding layer; and a secondary coating layer in contact with and surrounding said primary coating layer. According to this fourth aspect, the primary coating layer is a cured product of a radiation curable composition according to any of the embodiments of the first aspect or the second aspect, and the primary and secondary coatings are applied and cured according to any of the embodiments of the third aspect.

### DETAILED DESCRIPTION

A first aspect of the current invention is an optical fiber primary coating composition comprising, or consisting essentially of, or consisting of, relative to the weight of the entire primary coating composition:
(a) between 70 wt. % to 99 wt. % of one or more oligomers which is the reaction product of (i) a hydroxy- or thiol-functional backbone compound, (ii) an isocyanate compound; and (iii) a hydroxyl-functional end-capper; wherein a molar ratio of the number of isocyanate groups in (ii) to a number of hydroxyl-groups and thiol groups in (i) is less than or equal to 1.0;
(b) optionally, one or more urethane (meth)acrylate oligomers other than (a);
(c) optionally, one or more reactive diluent monomer;
(d) one or more photoinitiator;
(e) optionally, one or more additives;
   wherein if (b) is not present, the one or more oligomers according to (a) possesses at least one ethylenically unsaturated group, preferably at least one or two ethylenically unsaturated groups.

A second aspect of the current invention, meanwhile, also pertains to radiation curable formulations which may be suitable for use as an optical fiber primary coating composition. Specifically, a second aspect of the current invention is: a radiation curable formulation characterized in that the formulation comprises, or consists essentially of, or consists of:
(a) one or more monofunctional telechelic (meth)acrylate oligomers with 0-5 urethane groups and a number average molecular weight (Mn) from 750-20000 g/mol, wherein the one or more monofunctional telechelic (meth)acrylate oligomers according to (a) comprises a telechelic hydroxyl group;
(b) one or more di- or trifunctional telechelic urethane (meth)acrylate oligomers with at least 4 urethane groups and an Mn from 750-100000 g/mol;
wherein a molar ratio of (b) to (a) is from 0.01 to 1.5;
(c) optionally, one or more reactive diluent with an Mn of less than 500 g/mol;
(d) one or more photoinitiator; and
(e) optionally, one or more additives comprising an adhesion promoter and/or a stabilizer.

Radiation curable compositions for coating optical fibers according to the first and second aspects of the present invention therefore may contain an oligomer (a), a second oligomer (b), a reactive diluent component (c), a photoinitiator component (d), and an additive component (e). Such components described below may be used in compositions or formulations according to any of the aspects of the present invention, including the optical fiber primary coating compositions according to the first aspect, the radiation curable formulations according to the second aspect, the primary coating compositions used in the methods for coating an optical fiber according to the third aspect, and the compositions which are applied and cured onto the optical fibers described in association with the fourth aspect.

It has surprisingly been found that oligomers (a) tend to possess lower viscosity values. It has surprisingly been found that the presence of such oligomer in an optical fiber primary coating composition may beneficially contribute to the ability to lower the volatile content of the optical fiber primary coating composition while still being suitable for use in optical fiber coating applications, in particular maintaining an acceptable viscosity and cure speed and on-fiber performance as has come to be expected by the industry.

### Oligomer Component

Radiation curable compositions according to the present invention comprise an oligomer component; that is, a collection of one or more than one individual oligomers having one or more than one specified structure or type. An oligomer is used herein to mean a molecule of intermediate relative molecular mass, the structure of which comprises a plurality of units derived, actually or conceptually, from molecules of lower relative molecular mass. As used herein, a component is considered an oligomer if it further possesses a number average molecular weight (Mn) of greater than or equal to 750 g/mol, preferably of greater than about 1 kilodalton (kDa), preferably as measured via a size exclusion chromatography method (SEC) as described elsewhere herein. It will be understood by the skilled artisan that oligomers having Mn values in this range generally are less volatile than their low molecular weight analogues, and therefore-beneficially-would be less likely to migrate from the primary coating composition to the glass tube surrounding the optical fiber during the draw process.

In an embodiment, the oligomer component comprises, consists of, or consists essentially of one or more oligomers having an Mn of at least 750 g/mol, or at least 1 kilo Dalton (kDa), or at least 2 kDa, or at least 3 kDa, or at least 5 kDa, or at least 10 kDa, or at least 20 kDa, or at least 30 kDa, or at least 40 kDa, or from 20 to 150 kDa, or from 20 to 130 kDa, or from 20 to 100 kDa, or from 30 to 80 kDa, or from 35 to 55 kDa. According to other embodiments, the oligomer component comprises, consists of, or consists essentially of one or more oligomers possessing a theoretical molecular weight (Mn, theo) of at least 1 kDa, or at least 5 kDa, or at least 10 kilo Daltons (kDa), more preferably greater than 12 kDa, more preferably greater than 15 kDa, more preferably greater than 17 kDa, and/or less than 150 kDa, more preferably less than 140 kDa, more preferably less than 130 kDa, more preferably less than 120 kDa, or from 1 to 100 kDa, or from 1 to 50 kDa, or from 1 to 25 kDa, or from 15 to 120 kDa, or from 20 to 120 kDa, or from 25 to 120 kDa, or from 25 to 110 kDa, or from 25 to 100 kDa.

The oligomer component should comprise one or more reactive oligomers. As used herein, “reactive” means the ability to form a chemical reaction, preferably a polymerization reaction, with another molecule. As such, a reactive compound will be said to possess at least one reactive, or functional group. It is preferred that such reactive or functional group is a polymerizable group. Although some unreactive oligomers may be used in certain embodiments of the current invention, a large percentage of reactive oligomers is preferred. In an embodiment, the oligomer component consists of or consists essentially of reactive oligomers.

In other embodiments, the reactive oligomer is telechelic. As used herein, “telechelic” means that such component (i.e. oligomer in the present instance) contains reactive terminal groups on every chain end that are capable of forming intra-molecular as well as inter-molecular bonds.

The reactive oligomer component according to the invention preferably comprises, consists essentially of, or consists of reactive oligomers having at least one polymerizable group. In a preferred embodiment, the reactive oligomer component consists of reactive oligomers having at least one polymerizable group. The polymerizable groups may be of any known type. In an embodiment, however, the polymerizable group may comprise, consist essentially of, or consist of acrylate or methacrylate groups, or any combination thereof. The reactive oligomers are preferably ethylenically unsaturated polymerizable compounds that contain one or more than one reactive ethylenic double bond.

The polymerizable groups may occur at any feasible point along the length of the reactive oligomer, including as polymerizable backbone groups or polymerizable endgroups. Polymerizable backbone groups are present along, or branch from, a linear chain along the length of the oligomer, whereas polymerizable endgroups are polymerizable groups that are present at a terminus of the oligomer. The polymerizable groups may occur in isolation from, or directly or indirectly adjacent to other polymerizable groups, such as in a branched or forked pattern at a terminus (synonymously referred to herein as a “termination point”) of an oligomer, for example. In a preferred embodiment, the polymerizable groups comprise, consist essentially of, or consist of polymerizable endgroups.

Reactive oligomers according to the present invention may be of any known type consistent with the definitions specified elsewhere herein. According to the first and second aspects, however, the oligomer component preferably comprises, consists of, or consists essentially of one or more urethane oligomers, preferably reactive urethane oligomers. A urethane oligomer includes at least one urethane group or moiety, and preferably comprises at least a backbone, a polymerizable group, and a urethane group which links the backbone to the polymerizable group. In various embodiments, the reactive oligomer contains from 0-5 urethane groups, or 4 or more urethane groups. As used herein, the number of urethane groups are calculated based on the ideal structure. According to certain embodiments, the urethane oligomer comprises the reaction product of (i) a hydroxy- or thiol-functional backbone compound, such as a polyol; (ii) an isocyanate compound, preferably a polyisocyanate; and (iii) an isocyanate-reactive hydroxyl-functional end-capper, preferably also with a (meth)acrylate moiety. In a preferred embodiment, the urethane oligomer possesses an Mn from 1000 g/mol to 10,000 g/mol, or from 1200 g/mol to 9,000 g/mol.

Examples of suitable hydroxy- or thiol-functional backbone compounds include polyether polyols, polyester polyols, polycarbonate polyols, polycaprolactone polyols, acrylic polyols, and other polyols. These polyols may be used either individually or in combinations of two or more. In a preferred embodiment, the backbone of the urethane oligomer comprises the reaction product of a polyether polyol. In an embodiment, the backbone comprises the reaction product of a polypropylene glycol (PPG). As used herein, a compound derived from a polypropylene glycol includes an endcapped PPG, such as an EO-endcapped PPG. There are no specific limitations to the manner of polymerization of the structural units in these polyols. Each of random polymerization, block polymerization, or graft polymerization is acceptable.

As used herein, a block copolymer means a portion of an oligomer or polymer, comprising many constitutional units, wherein at least one constitutional unit comprises a feature that is not present in adjacent portions. As used herein, mono-, di-, and tri-block copolymers refer to the average amount of a particular block present in the oligomer. In a preferred embodiment, the particular block refers to a polyether block, which is derived from one or more of the polyols, preferably polyether polyols, described elsewhere herein. In an embodiment, the block to which a mono-, di-, and/or tri-block copolymer refers is a polyether block which is derived from one or more of the polyols described elsewhere herein. In an embodiment, a monoblock copolymer may be described as a copolymer having only an average of around 1, or from about 0.9 to less than 1.5 units of a particular block, such as a polyether block. In an embodiment, a diblock copolymer may be described as a copolymer having an average of around 2, or from at least 1.5 to less than 2.5 units of a particular block, such as a polyether block. In an embodiment, a triblock copolymer may be described as a copolymer having an average of around 3, or from at least 2.5 to less than 3.5 units of a particular block, such as a polyether block. The number of polyether units in a given oligomer may be determined by the number of polyether polyol molecules utilized in the synthesis of a single oligomer.

Given as examples of the polyether polyols are polyethylene glycol, polypropylene glycol, polypropylene glycol-ethylene glycol copolymer, polytetramethylene glycol, polyhexamethylene glycol, polyheptamethylene glycol, polydecamethylene glycol, and polyether diols obtained by ring-opening copolymerization of two or more ion-polymerizable cyclic compounds. Here, given as examples of the ion-polymerizable cyclic compounds are cyclic ethers such as ethylene oxide, isobutene oxide, tetrahydrofuran, 2-methyltetrahydrofuran, 3-methyltetrahydrofuran, dioxane, trioxane, tetraoxane, cyclohexene oxide, styrene oxide, epichlorohydrin, isoprene monoxide, vinyl oxetane, vinyl tetrahydrofuran, vinyl cyclohexene oxide, phenyl glycidyl ether, butyl glycidyl ether, and glycidyl benzoate. Specific examples of combinations of two or more ion-polymerizable cyclic compounds include combinations for producing a binary copolymer such as tetrahydrofuran and 2-methyltetrahydrofuran, tetrahydrofuran and 3-methyltetrahydrofuran, and tetrahydrofuran and ethylene oxide; and combinations for producing a ternary copolymer such as a combination of tetrahydrofuran, 2-methyltetrahydrofuran, and ethylene oxide, a combination of tetrahydrofuran, butene-1-oxide, and ethylene oxide, and the like. The ring-opening copolymers of these ion-polymerizable cyclic compounds may be either random copolymers or block copolymers.

Included in these polyether polyols are products commercially available such as, for example, PTMG1000, PTMG2000 (manufactured by Mitsubishi Chemical Corp.), PEG #1000 (manufactured by Nippon Oil and Fats Co., Ltd.), PTG650 (SN), PTG1000 (SN), PTG2000 (SN), PTG3000, PTGL1000, and PTGL2000 (manufactured by Hodogaya Chemical Co., Ltd.), PEG400, PEG600, PEG1000, PEG1500, PEG2000, PEG4000, and PEG6000 (manufactured by Daiichi Kogyo Seiyaku Co., Ltd.), P710R, P1010, P2010, and the 1044 Pluracol® P Series (by BASF), the Acrol® and Acclaim® series including PPG725, PPG1000, PPG2000, PPG3000, PPG4000, and PPG8000, as well as the Multranol® series including PO/EO polyether diols having a Mw of 2800 or 40000 (by Covestro). Additionally, AGC Chemicals provides diols under the trade name Preminol®, such as Preminol S 4013F (Mw 12,000), Preminol 4318F (Mw 18,000), and Preminol 5001F (Mw 4,000).

Polyester diols obtained by reacting a polyhydric alcohol and a polybasic acid are examples of polyester polyols. Examples of the polyhydric alcohol include ethylene glycol, polyethylene glycol, tetramethylene glycol, polytetramethylene glycol, 1,6-hexanediol, 3-methyl-1,5-pentanediol, 1,9-nonanediol, 2-methyl-1,8-octanediol, and the like. Examples of the polybasic acid include phthalic acid, dimer acid, isophthalic acid, terephthalic acid, maleic acid, fumaric acid, adipic acid, sebasic acid, and the like.

These polyester polyol compounds are commercially available under the trade names such as MPD/IPA500, MPD/IPA1000, MPD/IPA2000, MPD/TPA500, MPD/TPA1000, MPD/TPA2000, Kurapol® A-1010, A-2010, PNA-2000, PNOA-1010, and PNOA-2010 (manufactured by Kuraray Co., Ltd.).

Triols, such as polyester or polyether triols are also known. Especially preferred for use herein are oligo-triols, which have the general formula: A ( - - - OH)₃; wherein A is a chemical organic structure, such as an aliphatic, cycloaliphatic, aromatic, or heterocyclic structure, “ - - - ” is an oligomeric chain, such as a polyether chain, a polyester chain, a polyhydrocarbon chain, or a polysiloxane chain, to name a few, and “OH” is a terminal hydroxy group. In an embodiment, the triol comprises, consists of, or consists essentially of a polyether triol, a PO homopolymer, a PE homopolymer, PO-EO block copolymers, random copolymer or hybrid block-random copolymers. In practice, polyether triols may be based on glycerol or trimethylolpropane, PO, EO or PO and EO copolymer with EO on terminal block or internal block and a MW of 500~15,000 Daltons. Another type of polyether triol are copolymers based on glycerol or trimethylolpropane, such as THF-PO, THF-EO, THF-PO-EO or THF-EO-PO and having a molecular weight between about 500 and 15,000 g/mol. In an embodiment, the triol is derived from bio-based or natural reactants, such as certain vegetable oils and fats.

Commercial examples of suitable triols include the relevant propylene oxide-based polyether triols available from Carpenter under the Carpol® GP-designation, such as GP-1000, GP-1500, GP-1500-60, GP-3000, GP-4000, GP-5017, GP-5017-60, GP-5171, GP-6015, GP-6015-60, GP-6037-60, and GP-700. Further triols are commercially available from Covestro under the Arcol® brand, such as Arcol LHT-240 (Molecular weight “Mw” stated by the manufacturer of approximately 700 g/mol), Arcol LHT-112 (Mw 1500 g/mol), Arcol LHT LG-56 (Mw 3000 g/mol), and Arcol LHT-42 (Mw 4200 g/mol), the Multranol® tradename such as Multranol 9199 (Mw 4525 g/mol), Multranol 3900 (Mw 4800 g/mol), Multranol 3901 (Mw 6000 g/mol), and Multranol 9139 (Mw 6000 g/mol), as well as those under the trade name Acclaim® such as Acclaim 703 (Mw 700 g/mol), Acclaim 3300N (Mw 3000 g/mol), Acclaim 6300 (Mw 6000 g/mol), and Acclaim 6320 (Mw 6000 g/mol). Additionally, AGC Chemicals provides triols under the trade name Preminol®, such as Preminol S 3011 (Mw 10,000 g/mol), Preminol 7001K (Mw 7,000 g/mol), and Preminol 7012 (Mw 10,000 g/mol).

There is no inherent limitation to the number of R—H groups present in the hydroxyl- or thiol-functional backbone compound (OH, and SH, respectively), although preferably the hydroxyl- or thiol-functional backbone compound possesses 4 or fewer R—H groups. In a preferred embodiment, (i) comprises a hydroxyl-functional backbone compound possessing at least two hydroxyl groups, or at least three hydroxyl groups, or four hydroxyl groups.

The theoretical molecular weight derived from the hydroxyl number of these polyols is usually from about 50 g/mol to about 15,000 g/mol, and preferably from about 500 and 12,000 g/mol, or from about 1,000 to about 8,000 g/mol.

In addition to hydroxy-functional compounds such as polyols, thiol-functional compounds may also be used as (i). Suitable thiol-functional compounds can be prepared from suitable hydroxyl-functional compounds via well-known methods.

In a preferred embodiment, (i) comprises, consists of, or consists essentially of hydroxyl-functional backbone compound. In an embodiment, the hydroxyl-functional backbone compound comprises a polyether, polyester, polybutadiene, polycarbonate, or silicone moiety.

The reactive urethane oligomer also preferably comprises the reaction product of (ii) a (poly) isocyanate compound. The reaction product of a (poly) isocyanate compound, preferably a diisocyanate compound, may be utilized to create the urethane group or moiety in the reactive urethane oligomer according to the first or second aspects of the invention. As used herein, an isocyanate compound is defined as any organic compound which possesses at least one isocyanate group per molecule. Examples of suitable isocyanates include diisocyanates such as 2,4-tolylene diisocyanate, 2,6-tolylene diisocyanate, (hydrogenated) xylylene diisocyanate, 1,3-xylylene diisocyanate, 1,4-xylylene diisocyanate, 1,5-naphthalene diisocyanate, m-phenylene diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone diisocyanate, methylenebis(4-cyclohexylisocyanate), 2,2,4-trimethylhexamethylene diisocyanate, 2,4,4 trimethyl hexamethylene diisocyanate, hexamethylene diisocyanate, 2,4- and/or 4,4′-methylenedicyclohexyl diisocyanate, methylene diphenyl diisocyanate, tetramethyl xylene diisocyanate, 1,5-pentane diisocyanate, bis(2-isocyanato-ethyl) fumarate, 6-isopropyl-1,3-phenyl diisocyanate, 4-diphenylpropane diisocyanate, hydrogenated diphenylmethane diisocyanate, hydrogenated xylylene diisocyanate, tetramethyl xylylene diisocyanate, lysine isocyanate, and the like.

These diisocyanate compounds may be used either individually or in combinations of two or more. Preferred diisocyanates are isophorone diisocyanate, 2,2,4-trimethylhexamethylene diisocyanate, 2,4,4 trimethyl hexamethylene diisocyanate and hexamethylene diisocyanate, 2,4-tolylene diisocyanate, and 2,6-tolylene diisocyanate.

As used herein, “polyisocyanate” indicates that the isocyanate compound has two or more isocyanate moieties per molecule. In an embodiment, the oligomer component comprises, consists essentially of, or consists of a urethane oligomer which is the reaction product of one or more polyisocyanates. In addition to the diisocyanates specified above, polyisocyanates having three isocyanate groups per molecule, i.e. triisocyanates, may also be used. Known triisocyanates include biurets made from hexamethylene diisocyanate (HDI) or HDI trimers, which are commercially available from Covestro under the Desmodur® tradename and including, without limitation, Desmodur N 3200, Desmodur N 3300, Desmodur N 3390, Desmodur N 3600, Desmodur N 3800, Desmodur N 3900, Desmodur N XP 2580, Desmodur XP 2599, Desmodur XP 2675, Desmodur XP 2731, Desmodur XP 2714 and Desmodur XP 2803.

Further commercially-available triisocyanates include the Vestanat® T (IPDI-trimer) and HT (HDI-trimer) lines of polyisocyanate crosslinkers for 2 k systems, available from Evonik.

The reactive urethane oligomer also preferably comprises the reaction product of (iii) a hydroxyl-functional end-capper. The compound according to (iii) is preferably reactive with the isocyanate compound from (ii). Preferably, the urethane oligomer also comprises the reaction product of an isocyanate-reactive compound having an ethylenically unsaturated moiety as (iii). Preferably, the ethylenically unsaturated moiety is a (meth)acrylate moiety. Any suitable (meth)acrylates can be used, including monomers and oligomers, although (meth)acrylate monomers are preferred. Such isocyanate-reactive (meth)acrylates preferably include hydroxyl group-containing (meth)acrylate compounds, as such compounds are known to be reactive with isocyanates, including the polyisocyanates of (ii). Examples of the hydroxyl group-containing (meth)acrylates include (meth)acrylates derived from (meth)acrylic acid and epoxy and (meth)acrylates comprising alkylene oxides, more in particular, 2-hydroxy ethyl (meth)acrylate, 2-hydroxypropyl (meth)acrylate, 2-hydroxy-3-phenoxypropyl (meth)acrylate, and hydroxyethyl caprolactone acrylate, ethoxylated trimethylolpropane diacrylate, glycerol di(meth)acrylate, and glycerol acrylate methacrylate (i.e., 3-(Acryloyloxy)-2-hydroxypropyl methacrylate). In a preferred embodiment, (iii) comprises, consists essentially of, or consists of hydroxyethyl (meth)acrylate, 2-hydroxypropyl (meth)acrylate, 3-hydroxypropyl (meth)acrylate, 4-hydroxybutyl (meth)acrylate, caprolactone (meth)acrylate, glycerol acrylate methacrylate, glycerol di(meth)acrylate, or combinations thereof.

The hydroxyl-functional end-capper (iii) preferably further comprises one or two ethylenically unsaturated moieties, more preferably the (iii) hydroxyl-functional end-capper further comprises one ethylenically unsaturated moiety. The compound according to (iii) may possess more than one hydroxyl group per molecule.

In the reaction of the components used to create a urethane oligomer, one or more urethanization catalysts are also preferably used. Such catalysts include, by way of an example, copper naphthenate, cobalt naphthenate, zinc naphthenate, bismuth, di-n-butyl tin dilaurate, triethylamine, and triethylenediamine-2-methyltriethyleneamine. The catalyst may be used in any suitable amount, or for example from about 0.01 to about 1 wt. % of the total amount of the reactant. The reaction may be carried out at any suitable temperature, such as a temperature from about 10 to about 90° C., and preferably from about 30 to about 80° C.

In an embodiment, the composition or formulation comprises at least one oligomer which further comprises the reaction product of a single PPG diol as (i); a single diisocyanate compound as (ii); and a hydroxyl-functional (meth)acrylate compound as (iii).

In various embodiments, the oligomer reactants (i), (ii), and (iii) are chosen and configured in prescribed ratios. In an embodiment, the composition comprises at least one oligomer having a molar ratio of the number of isocyanate groups in (ii) to a number of hydroxyl-groups and thiol groups in (i) of less than or equal to 1.0. In another embodiment, the composition comprises at least one oligomer having a molar ratio of the number of isocyanate groups in (ii) to the number of hydroxyl groups and thiol groups in (i) of greater than or equal to 2:3 and less than or equal to 1.0. Thus, in certain embodiments, the composition possesses at least one oligomer having the aforementioned molar ratio of preferably between about 0.67 and 1.0. Surprisingly, inventors have discovered that oligomers (which are otherwise according to the requirements and preferences as specified herein) configured in this way tend to possess lower viscosity values. This is helpful as the use of such oligomers tends to minimize the requirement for large quantities of volatile diluents and can thereby be included in the overall composition in larger quantities.

In an embodiment, therefore, the composition or formulation comprises at least one oligomer having a viscosity of less than 15 Pa·s, or less than 12, or less than 10 Pa·s, or between 1 and 15 Pa·s, or between 2 and 12 Pa·s, or between 3 and 10 Pa·s, wherein viscosity is measured at 25° C. and a shear rate of 2500 s⁻¹.

Various oligomers of the first and/or second aspect may be configured to possess a wide range of functionality. In an embodiment, at least one monofunctional oligomer is utilized. As used herein, “monofunctional” means possession of an average of between 0.5 to 1.4 polymerizable groups per molecule, as determined by, for example, a nuclear magnetic resonance spectroscopy (NMR) method.

In an embodiment, difunctional oligomers and/or trifunctional oligomers may additionally or alternatively be used. As used herein, “difunctional” means possession of an average of between 1.95 to 2.05 polymerizable groups per molecule, as determined by, for example, an NMR method. Similarly, “trifunctional” is used herein to mean an average of from 2.95 to 3.05 polymerizable groups per molecule. In a preferred embodiment, the oligomer component comprises, consists essentially of, or consists of one or more reactive urethane oligomers having an average (meth)acrylate functionality of between 1.5 and 4.2, or from 1.8 to 3.8, or from 1.8 to 3.2, or from 1.8 to 2.8. In an embodiment, the average (meth)acrylate functionality of the oligomer component is between 1.5 and 4.2, or from 1.8 to 3.8, or from 1.8 to 3.2, or from 1.8 to 2.8.

In a preferred embodiment, the composition or formulation contains at least one oligomer which is difunctional or higher to facilitate adequate crosslinking for use as an optical fiber primary coating. In further embodiments, the composition or formulation contains a mixture of different oligomers having different functionalities, such as at least one monofunctional oligomer and at least one difunctional oligomer, or at least one monofunctional oligomer and at least one trifunctional oligomer, or at least one monofunctional oligomer, at least one difunctional oligomer, and at least one trifunctional oligomer. Of course, other combinations can be envisioned by the skilled artisan to which this invention applies.

According to many embodiments of the first and second aspect, the composition or formulation contains more than one oligomer. In embodiments of the first aspect, the optical fiber primary coating composition comprises (a) one or more oligomers which is the reaction product of (i) a hydroxy- or thiol-functional backbone compound, (ii) an isocyanate compound; and (iii) a hydroxyl-functional end-capper, whereby a molar ratio of (ii) to (i) of less than or equal to 1.0 as described above, and optionally also (b), one or more urethane (meth)acrylate oligomers other than that referred to in (a). In embodiments of the first aspect, the one or more oligomers according to (a) is present in a large quantity with respect to the entire associated composition, such as from 70 wt. % to 99 wt. %, or from 80 wt. % to 96 wt. %.

Because it is incorporated in such high amounts in the entire composition, the one or more oligomers (a) is preferably configured so as to possess a viscosity low enough to enable sufficient processing in optical fiber coating applications. As described above, the aforementioned molar ratios of (ii) to (i) may beneficially contribute to this property of oligomer (a). Alternatively or additionally, the overall number of urethane linkages present in the one or more oligomers (a) may also beneficially contribute thereto. Thus, in an embodiment, the oligomers according to (a) possess from 1.8 to 2.2 urethane linkages per molecule. Thirdly, Inventors have surprisingly discovered that by configuring the oligomer such that it is terminated at one end by a hydroxyl group, it is possible to yield an oligomer with a sufficiently low viscosity.

In other embodiments of the first aspect, the one or more oligomers (b) is present, preferably in an amount of 29.95 wt. % or less relative to the entire associated composition. The one or more oligomer (b) may also comprise the reaction product of (i) a hydroxy-functional backbone compound, (ii) an isocyanate compound, and (iii) a hydroxyl-functional end-capper. However, as opposed to the one or more oligomers (a), according to certain embodiment the one or more oligomers (b) possesses a molar ratio of the number of isocyanate groups in (ii) to the number of hydroxyl-groups in (i) in the urethane (meth)acrylate oligomer (b) of greater than 1.0, or from about 1.5 to about 2.0.

According to embodiments of the second aspect, meanwhile, the radiation curable formulation also comprises at least two different oligomers (a) and (b), which are present in a molar ratio of (b) to (a) from 0.01 to 1.5, or from 0.02 to 1.5, or from 0.04 to 1.5, or from 0.06 to 1.5, or from 0.02 to 1.2, or from 0.06 to 1.2, or from 0.02 to 1, or from 0.04 to 1, or from 0.06 to 1, or from 0.02 to 0.8, or from 0.06 to 0.8, or from 0.02 to 0.6, or from 0.04 to 0.6, or from 0.06 to 0.6. The one or more oligomers (a) according to the second aspect is a monofunctional telechelic (meth)acrylate oligomer having from 0 to 5 urethane groups, preferably from 0 to 3 urethane groups, preferably from 1 to 3 urethane groups, more preferably 2 urethane groups, and also comprises a telechelic hydroxyl group, and an Mn value from 750 to 20,000 g/mol, or least 1000 g/mol, or at least 1250 g/mol, or at least 1500 g/mol, and/or at most 18,000 g/mol, or at most 16,000 g/mol, or at most 15,000 g/mol.

Oligomer (b) according to the second aspect, meanwhile, is one or more di- or trifunctional telechelic urethane (meth)acrylate oligomer with at least 4 urethane groups and an Mn from 750 to 100,000 g/mol, or at least 1000 g/mol, or at least 1250 g/mol, or at least 1500 g/mol, or an Mn of less than 60,000 g/mol, or less than 40,000 g/mol, or less than 30,000 g/mol, or between 1000 to 20,000 g/mol, or between 1500 to 15,000 g/mol. In a preferred embodiment, the one or more oligomer (b) is a polyether oligomer.

Regardless of whether included in the first or second aspect, it is preferable that the total oligomer content (whether (a) alone or also including (b) if present) is very high, relative to the weight of the entire composition with which such oligomer or oligomers are associated. In an embodiment, the oligomers are present in an amount of at least 60 wt. %, or at least 65 wt. %, or at least 70 wt. %, or at least 80 wt. %, or at least 90 wt. %, or at least 95 wt. %, or at least 98 wt. %, relative to the weight of the entire composition.

### Reactive Diluent Component (c)

Compositions according to the first aspect and/or second aspect of the present invention also include a diluent component (c); that is, a collection of one or more than one individual diluents having one or more than one specified structure or type. As used herein, a “diluent” means a substance which reduces the viscosity of the greater composition into which it is added or with which it is associated. A variety of diluents are used to maximize the flowability, and in turn the processability, of the optical fiber coating compositions with which they are associated.

To maximize curability of the composition associated therewith, the diluent component preferably comprises, consists of, or consists essentially of reactive diluents. As specified with respect to the qualification of the oligomer component described elsewhere herein, “reactive” means the ability to form a chemical reaction, preferably a polymerization reaction, with another molecule. As such, a reactive compound will be said to possess at least one reactive, or functional, group. It is preferred that such reactive or functional group is a polymerizable group.

It is further preferable that the diluent component comprises, consists of, or consists essentially of reactive diluent monomers. A monomer is a molecule of low relative molecular mass, the structure of which can undergo polymerization thereby contributing constitutional units to the essential structure of a macromolecule. As used herein, a component is considered a monomer if it further possesses a number average molecular weight (Mn) that is less than about 1000 g/mol. In an embodiment, the reactive diluent component consists of one or more reactive diluent monomers having an Mn from about 86 g/mol (the molar mass of methyl acrylate) to 750 g/mol, or from 100 g/mol to 350 g/mol, as determined by an NMR method. In embodiments according to the second aspect, the reactive diluent possesses an Mn of less than 500 g/mol.

The diluent component according to the invention comprises, consists essentially of, or consists of reactive diluent monomers having at least one polymerizable group. In a preferred embodiment, the reactive diluent monomer component consists of reactive diluent monomers having, on average, one polymerizable group. The polymerizable group(s) of the reactive diluent monomer are preferably able to (co) polymerize with the polymerizable groups present in the associated reactive oligomer component.

The polymerizable groups of the reactive diluent may be of any known type. In an embodiment, however, the polymerizable group may comprise, consist essentially of, or consist of acrylate, acrylamide, or N-vinyl amide groups, or any combination thereof. The reactive diluents are preferably ethylenically unsaturated polymerizable compounds that contain at least one reactive olefinic double bond.

The polymerizable group(s) may occur at any feasible point along the length of the reactive diluent. In a preferred embodiment, however the polymerizable groups comprise, consist essentially of, or consist of polymerizable endgroups.

The diluent component according to the present invention may include any known type of compound or substance consistent with the definitions specified elsewhere herein. In a preferred embodiment, however, the diluent component comprises, consists essentially of, or consists of one or more reactive diluent monomers containing one double bond.

Typical examples of such reactive diluent monomers containing one double bond are alkyl or hydroxyalkyl acrylates, for example methyl, ethyl, butyl, 2-phenoxy ethyl, 2-ethylhexyl, and 2-hydroxyethyl acrylate, isobornyl acrylate, methyl and ethyl acrylate, lauryl-acrylate, ethoxylated nonyl-phenol acrylate, and diethylene-glycol-ethyl-hexyl acylate (DEGEHA). Further examples of these monomers are acrylonitrile, acrylamide, N-substituted acrylamides, vinyl esters such as vinyl acetate, styrene, alkylstyrenes, halostyrenes, N-vinylpyrrolidone, N-vinyl amides such as N-vinyl caprolactam, vinyl chloride and vinylidene chloride. Examples of monomers containing more than one double bond are ethylene glycol diacrylate, propylene glycol diacrylate, tripropylene glycol diacrylate, neopentyl glycol diacrylate, hexamethylene glycol diacrylate, bisphenol A diacrylate, 4,4′-bis(2-acryloyloxyethoxy)diphenyl propane, trimethylolpropane triacrylate, pentaerythritol triacrylate and tetraacrylate, and vinyl acrylate.

In a preferred embodiment, if used, component (c) comprises 2-ethylhexyl acrylate, 2-phenoxyethyl acrylate, 2-(2-ethoxyethoxy)ethyl acrylate, n-vinyl pyrrolidone, dimethylacryl-amide, n-vinylcaprolactam, ethoxylated 2-phenoxy ethyl acrylate, 4-hydroxy butyl acrylate, lauryl acrylate, isobornyl acrylate, caprolactone acrylate, ethoxylated nonylphenol acrylate, tridecyl acrylate, or isodecyl acrylate, or combinations thereof.

In a preferred embodiment, the diluent component comprises, consists essentially of, or consists of one or more monofunctional diluent monomers. In a preferred embodiment, the diluent component comprises, consists of, or consists essentially of functional monomers, such as (meth)acrylic monomers.

One or more of the aforementioned diluents can be employed in compositions according to the present invention in any suitable amount in order to tune the viscosity of the formulation with which they are associated to be suitable for the optical fiber coating process to be used therewith according to methods well-known in the art to which this invention applies, and may be chosen singly or in combination of one or more of the types enumerated herein. In an embodiment, the diluent component is present in an amount, relative to the entire weight of the radiation curable composition, from 20 wt. % to 85 wt. %, or from 30 to 85 wt. %, or from 30 to 80 wt. %, or from 30 to 75 wt. %, or from 30 to 70 wt. %, or from 30 to 65 wt. %, or from 30 to 60 wt. %, or from 30 to 50 wt. %, or from 35 to 85 wt. %, or from 35 to 75 wt. %, or from 35 to 65 wt. %, or from 35 to 55 wt. %, or from 40 to 85 wt. %, or from 40 to 75 wt. %, or from 40 to 65 wt. %, or from 40 to 55 wt. %, or from 50 to 85 wt. %, or from 50 to 75 wt. %, or from 50 to 65 wt. %.

In various preferred embodiments, however, it is desirable to minimize the amount of low-molecular weight components present in the composition or formulation. This is because such components are inherently more volatile than their higher molecular weight oligomeric analogues and have a greater tendency to evaporate or separate from the liquid composition during application. Such a problem is particularly acute in situations where the composition is exposed and maintained at higher temperatures, such as that which is experienced during high-speed application and processing onto an optical fiber. Evaporation of volatiles during an optical fiber curing process is highly undesirable because such volatile components later condense or coalesce onto the inner surface of the tube in which the fiber coating process occurs. As more components settle onto the tube surface, they necessarily inhibit the ability of the radiation source to efficiently cure the optical fiber coating composition as they block a portion of the light from reaching it. In addition to this, such volatiles gum up the inner surface of the tube, thereby requiring more frequent inconvenient and process-stopping cleaning operations. Inventors have surprisingly discovered that, by constructing compositions or formulations of the type prescribed herein, such as by including the oligomers (a) and (b) described above, it is possible to reduce the quantity of reactive diluents present in the composition and still maintain sufficient cure speed, processability, and on-fiber performance.

Therefore, in a preferred embodiment, component (c) is present in an amount, relative to the entire weight of the composition or formulation with which it is associated, of less than 40 wt. %, or less than 30 wt. %, or 29.95 wt. % or less, or less than 30 wt. %, or less than 20 wt. %, or less than 10 wt. %, or less than 5 wt. %, or less than 2 wt. %. In still other preferred embodiments, component (c) is absent from the composition or formulation altogether.

### Photoinitiator Component (d)

According to the first and second aspects, the composition and/or formulation preferably includes a photoinitiator component; that is, a collection of one or more than one individual photoinitiators having one or more than one specified structure or type. A photoinitiator is a compound that chemically changes due to the action of light or the synergy between the action of light and the electronic excitation of a sensitizing dye to produce at least one of a radical, an acid, and a base. Well-known types of photoinitiators include cationic photoinitiators and free-radical photoinitiators. According to an embodiment of the present invention, the photoinitiator is a free-radical photoinitiator.

In an embodiment, the photoinitiator component includes, consists of, or consists essentially of one or more acylphosphine oxide photoinitiators. Acylphosphine oxide photoinitiators are known, and are disclosed in, for example, U.S. Pat. Nos. 4,324,744, 4,737,593, 5,942,290, 5,534,559, 6,020,529, 6,486,228, and 6,486,226. Preferred types of acylphosphine oxide photoinitiators for use in the photoinitiator component include bisacylphosphine oxides (BAPO) or monoacylphosphine oxides (MAPO). More specifically, examples include 2,4,6-trimethylbenzoylethoxyphenylphosphine oxide (CAS #84434-11-7) or 2,4,6-trimethylbenzoyldiphenylphosphine oxide (CAS #127090-72-6).

The photoinitiator component may also optionally comprise, consist of, or consist essentially of α-hydroxy ketone photoinitiators. For instance, suitable α-hydroxy ketone photoinitiators are α-hydroxycyclohexyl phenyl ketone, 2-hydroxy-2-methyl-1-phenylpropanone, 2-hydroxy-2-methyl-1-(4-isopropylphenyl) propanone, 2-hydroxy-2-methyl-1-(4-dodecylphenyl) propanone, 2-Hydroxy-1-{4-[4-(2-hydroxy-2-methyl-propionyl)-benzyl]-phenyl}-2-methyl-propan-1-one and 2-hydroxy-2-methyl-1-[(2-hydroxyethoxy)phenyl]propanone.

In another embodiment, the photoinitiator component includes, consists of, or consists essentially of: α-aminoketones, such as 2-methyl-1-[4-(methylthio)phenyl]-2-(4-morpholinyl)-1-propanone, 2-benzyl-2-(dimethylamino)-1-[4-(4-morpholinyl)phenyl]-1-butanone, 2-(4-methylbenzyl-2-(dimethylamino)-1-[4-(4-morpholinyl)phenyl]-1-butanone or 2-benzyl-2-(dimethylamino)-1-[3,4-dimethoxyphenyl]-1-butanone; benzophenones, such as benzophenone, 2,4,6-trimethylbenzophenone, 4-methylbenzophenone, 2-methylbenzophenone, 2-methoxycarbonylbenzophenone, 4,4′-bis(chloromethyl)-benzophenone, 4-chlorobenzophenone, 4-phenylbenzophenone, 4,4′-bis(dimethylamino)-benzophenone, 4,4′-bis(diethylamino)benzophenone, methyl2-benzoylbenzoate, 3,3′-dimethyl-4-methoxybenzophenone, 4-(4-methylphenylthio)benzophenone, 2,4,6-trimethyl-4′-phenyl-benzophenone or 3-methyl-4′-phenyl-benzophenone; ketal compounds, for example 2,2-dimethoxy-1,2-diphenyl-ethanone; and monomeric or dimeric phenylglyoxylic acid esters, such as methylphenylglyoxylic acid ester, 5,5′-oxo-di(ethyleneoxydicarbonylphenyl) or 1,2-(benzoylcarboxy)ethane.

Yet further suitable photoinitiators for use in the photoinitiator component include oxime esters, such as those disclosed in U.S. Pat. No. 6,596,445. Still another class of suitable photoinitiators for use in the photoinitiator component include, for example, phenyl glyoxalates, for example those disclosed in U.S. Pat. No. 6,048,660.

In another embodiment, the photoinitiator component may comprise, consist of, or consist essentially of one or more alkyl-, aryl-, or acyl-substituted compounds not mentioned above herein.

According to another embodiment, the composition may contain a photoinitiator that is an alkyl-, aryl-, or acyl-substituted compound. In an embodiment the alkyl-, aryl-, or acyl-substituted photoinitiator possesses or is centered around an atom in the Carbon (Group 14) group. In such instance, upon excitation (via absorption of radiation) the Group 14 atom present in the photoinitiator compound forms a radical. Such compound may therefore produce a radical possessing or centered upon an atom selected from the group consisting of silicon, germanium, tin, and lead. In an embodiment, the alkyl-, aryl-, or acyl-substituted photoinitiator is an acylgermanium compound. Such photoinitiators are described in, U.S. Pat. No. 9,708,442, assigned to Covestro (Netherlands) B.V., which is hereby incorporated by reference in its entirety. Known specific acylgermanium photoinitiators include benzoyl trimethyl germane (BTG), tetracylgermanium, or bis acyl germanoyl (commercially available as Ivocerin® from Ivoclar Vivadent AG, 9494 Schaan/Liechtenstein).

Photoinitiators according to the present invention may be employed singularly or in combination of one or more as a blend. Suitable photoinitiator blends are for example disclosed in U.S. Pat. No. 6,020,528 and U.S. Pat. app. No. 60/498,848. According to an embodiment, the photoinitiator component includes a photoinitiator blend of, for example, bis(2,4,6-trimethylbenzoyl) phenyl phosphine oxide (CAS #162881-26-7) and 2,4,6,-trimethylbenzoylethoxyphenylphosphine oxide (CAS #84434-11-7) in ratios by weight of about 1:11, 1:10, 1:9, 1:8 or 1:7.

Another especially suitable photoinitiator blend is a mixture of bis(2,4,6-trimethylbenzoyl)phenyl phosphine oxide, 2,4,6,-trimethylbenzoylethoxyphenylphosphine oxide and 2-hydroxy-2-methyl-1-phenyl-1-propanone (CAS #7473-98-5) in weight ratios of for instance about 3:1:15 or 3:1:16 or 4:1:15 or 4:1:16. Another suitable photoinitiator blend is a mixture of bis(2,4,6-trimethylbenzoyl)phenyl phosphine oxide and 2-hydroxy-2-methyl-1-phenyl-1-propanone in weight ratios of for instance about 1:3, 1:4 or 1:5.

One or more of the aforementioned photoinitiators can be employed for use in the photoinitiator component in compositions according to the first aspect of the present invention in any suitable amount and may be chosen singly or in combination of one or more of the types enumerated herein. In a preferred embodiment, the photoinitiator component comprises, consists of, or consists essentially of free-radical photoinitiators. In an embodiment, the photoinitiator component is present in an amount, relative to the entire weight of the composition, of from about 0.1 wt. % to about 10 wt. %, or from about 0.1 wt. % to about 5 wt. %, or from about 1 wt. % to about 5 wt. %.

### Additives (e)

The compositions and/or formulations according to the first and second aspect of the invention optionally include an additive component; that is, a collection of one or more than one individual additives having one or more than one specified structure or type. Additives are also typically added to optical fiber coatings to achieve certain desirable characteristics such as improved adhesion to the glass optical fiber, improved shelf life, improved coating oxidative and hydrolytic stability, and the like. There are many different types of desirable additives, and the invention discussed herein is not intended to be limited by these, nevertheless they are included in the envisioned embodiments since they have desirable effects.

Examples additives for use in the additive component include thermal inhibitors, which are intended to prevent premature polymerization, examples being hydroquinone, hydroquinone derivatives, p-methoxyphenol, beta-naphthol or sterically hindered phenols, such as 2,6-di(tert-butyl)-p-cresol. The shelf life in the dark can be increased, for example, by using copper compounds, such as copper naphthenate, copper stearate or copper octoate, phosphorus compounds, for example triphenylphosphine, tributylphosphine, triethyl phosphite, triphenyl phosphite or tribenzyl phosphite, quaternary ammonium compounds, such as tetramethylammonium chloride or trimethylbenzylammonium chloride.

In order to keep out atmospheric oxygen during the polymerization, additives such as paraffin or similar wax-like substances can be added; these migrate to the surface on commencement of the polymerization because of their low solubility in the polymer and form a transparent surface layer which prevents the ingress of air. It is likewise possible to apply an oxygen barrier layer.

Further potentially suitable additives include light stabilizers. Light stabilizers include UV-absorbers such as the well-known commercial UV absorbers of the hydroxyphenylbenzotriazole, hydroxyphenyl-benzophenone, oxalamide or hydroxyphenyl-s-triazine type. It is possible to use individual such compounds or mixtures thereof, with or without the use of sterically hindered relatively non-basic amine light stabilizers (HALS). Sterically hindered amines are for example based on 2,2,6,6-tetramethylpiperidine. UV absorbers and sterically hindered amines include, for example the following:

2-(2-Hydroxyphenyl)-2H-benzotriazoles, for example known commercial hydroxyphenyl-2H-benzotriazoles and benzotriazoles, which are disclosed in U.S. Pat. Nos. 3,004,896; 3,055,896; 3,072,585; 3,074,910; 3,189,615; 3,218,332; 3,230,194; 4,127,586; 4,226,763; 4,275,004; 4,278,589; 4,315,848; 4,347,180; 4,383,863; 4,675,352; 4,681,905; 4,853,471; 5,268,450; 5,278,314; 5,280,124; 5,319,091; 5,410,071; 5,436,349; 5,516,914; 5,554,760; 5,563,242; 5,574,166; 5,607,987; 5,977,219; and 6,166,218 such as 2-(2-hydroxy-5-methylphenyl)-2H-benzotriazole, 2-(3,5-di-t-butyl-2-hydroxyphenyl)-2H-benzotriazole, 2-(2-hydroxy-5-t-butylphenyl)-2H-benzotriazole, 2-(2-hydroxy-5-t-octylphenyl)-2H-benzotriazole, 5-chloro-2-(3,5-di-t-butyl-2-hydroxyphenyl)-2H-benzotriazole, 5-chloro-2-(3-t-butyl-2-hydroxy-5-methylphenyl)-2H-benzotriazole, 2-(3-sec-butyl-5-t-butyl-2-hydroxyphenyl)-2H-benzotriazole, 2-(2-hydroxy-4-octyloxyphenyl)-2H-benzotriazole, 2-(3,5-di-t-amyl-2-hydroxyphenyl)-2H-benzotriazole, 2-(3,5-bis-α-cumyl-2-hydroxyphenyl)-2H-benzotriazole, 2-(3-t-butyl-2-hydroxy-5-(2-(ω-hydroxy-octa-(ethyleneoxy) carbonyl-ethyl)-, phenyl)-2H-benzotriazole, 2-(3-dodecyl-2-hydroxy-5-methylphenyl)-2H-benzotriazole, 2-(3-t-butyl-2-hydroxy-5-(2-octyloxycarbonyl)ethylphenyl)-2H-benzotriazole, dodecylated 2-(2-hydroxy-5-methylphenyl)-2H-benzotriazole, 2-(3-t-butyl-2-hydroxy-5-(2-octyloxycarbonylethyl)phenyl)-5-chloro-2H-benzotriazole, 2-(3-tert-butyl-5-(2-(2-ethylhexyloxy)-carbonylethyl)-2-hydroxyphenyl)-5-chloro-2H-benzotriazole, 2-(3-t-butyl-2-hydroxy-5-(2-methoxycarbonylethyl)phenyl)-5-chloro-2H-benzotriazole, 2-(3-t-butyl-2-hydroxy-5-(2-methoxycarbonylethyl)phenyl)-2H-benzotriazole, 2-(3-t-butyl-5-(2-(2-ethylhexyloxy) carbonylethyl)-2-hydroxyphenyl)-2H-benzotriazole, 2-(3-t-butyl-2-hydroxy-5-(2-isooctyloxycarbonylethyl)phenyl-2H-benzotriazole, 2,2′-methylene-bis(4-t-octyl-(6-2H-benzotriazol-2-yl)phenol), 2-(2-hydroxy-3-α-cumyl-5-t-octylphenyl)-2H-benzotriazole, 2-(2-hydroxy-3-t-octyl-5-α-cumylphenyl)-2H-benzotriazole, 5-fluoro-2-(2-hydroxy-3,5-di-α-cumylphenyl)-2H-benzotriazole, 5-chloro-2-(2-hydroxy-3,5-di-α-cumylphenyl)-2H-benzotriazole, 5-chloro-2-(2-hydroxy-3-α-cumyl-5-t-octylphenyl)-2H-benzotriazole, 2-(3-t-butyl-2-hydroxy-5-(2-isooctyloxycarbonylethyl)phenyl)-5-chloro-2H-benzotriazole, 5-trifluoromethyl-2-(2-hydroxy-3-α-cumyl-5-t-octylphenyl)-2H-benzotriazole, 5-trifluoromethyl-2-(2-hydroxy-5-t-octylphenyl)-2H-benzotriazole, 5-trifluoromethyl-2-(2-hydroxy-3,5-di-t-octylphenyl)-2H-benzotriazole, methyl 3-(5-trifluoromethyl-2H-benzotriazol-2-yl)-5-t-butyl-4-hydroxyhydrocinnamate, 5-butylsulfonyl-2-(2-hydroxy-3-α-cumyl-5-t-octylphenyl)-2H-benzotriazole, 5-trifluoromethyl-2-(2-hydroxy-3-α-cumyl-5-t-butylphenyl)-2H-benzotriazole, 5-trifluoromethyl-2-(2-hydroxy-3,5-dit-butylphenyl)-2H-benzotriazole, 5-trifluoromethyl-2-(2-hydroxy-3,5-di-α-cumylphenyl)-2H-benzotriazole, 5-butylsulfonyl-2-(2-hydroxy-3,5-di-t-butylphenyl)-2H-benzotriazole and 5-phenylsulfonyl-2-(2-hydroxy-3,5-di-t-butylphenyl)-2H-benzotriazole.

Another example class includes 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

Yet another example class includes esters of substituted and unsubstituted benzoic acids, as for example 4-tert-butylphenyl salicylate, phenyl salicylate, octylphenyl salicylate, dibenzoyl resorcinol, bis(4-tert-butylbenzoyl) resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

Additional additives suitable for use in the additive component include compounds which accelerate photopolymerization, such as so-called photosensitizers, which shift or broaden the spectral sensitivity of the composition into which they are incorporated. Photosensitizers include, in particular, aromatic carbonyl compounds, such as benzophenone derivatives, thioxanthone derivatives, anthraquinone derivatives and 3-acylcoumarin derivatives, and also 3-(aroylmethylene)thiazolines, and also eosine, rhodamine and erythrosine dyes. Alternatively, non-aromatic carbonyl compounds may be used. An example of a non-aromatic carbonyl is dimethoxy anthracene.

The curing procedure can be assisted in particular by using additives which create or facilitate the creation of pigmented compositions. Such additives include pigments such as titanium dioxide, and also include additives which form free radicals under thermal conditions, for example an azo compound such as 2,2′-azobis(4-methoxy-2,4-dimethylvaleronitrile), a triazene, a diazo sulfide, a pentazadiene or a peroxy compound, such as a hydroperoxide or peroxycarbonate, for example t-butyl hydroperoxide, as described in U.S. Pat. No. 4,753,817. Further suitable substances for this purpose include benzopinacol compounds.

The additive component may include a photo reducible dye, for example xanthene, benzoxanthene, benzothioxanthene, thiazine, pyronine, porphyrin or acridine dyes, and/or a trihalomethyl compound which can be cleaved by radiation. Such additives are described, for example, in U.S. Pat. No. 5,229,253.

Other conventional additives may be used depending on the intended application. Examples include fluorescent whiteners, fillers, pigments, dyes, wetting agents or levelling assistants. Thick and pigmented coatings can also contain glass microbeads or powdered glass fibers, as described in U.S. Pat. No. 5,013,768, for example.

In an embodiment, the additive component includes one or more of the various additives that are used to enhance one or more properties of the primary coating. Such additives include antioxidants (such as Irganox 1035, a thiodiethylene bis [3-(3,5-di-tert-butyl-4-hydroxyphenyl)propionate], or tert-Butylhydroquinone), adhesion promoters, inhibitors (such as acrylic acid), photosensitizers, carrier surfactants, tackifiers, catalysts, stabilizers, surface agents, and optical brighteners.

In a preferred embodiment, the additive component includes, consists of, or consists essentially of one or more adhesion promoter compounds. Adhesion promoters provide a link between the polymer primary coating and the surface of the optical glass fiber. Silane coupling agents, which are hydrolysable, have been used as glass adhesion promoters. Silane coupling agents are described in, i.a, U.S. Pat. No. 4,932,750. In an embodiment, the adhesion promoter is a hydrolysable silane compound which contains a mercapto group and/or a plurality of alkoxy groups. Such adhesion promoters are known and are described in, U.S. patent application No. 20020013383, the relevant portions of which are hereby incorporated by reference.

In an embodiment, the adhesion promoter includes one or more of gamma-mercaptopropyltrimethoxysilane, trimethoxysiliylpropyl acrylate, or 3-trimetoxysilylpropane-1-thiol. Silane coupling groups may alternatively be reacted onto oligomers in the oligomer component; in such case they will be considered not as an additive but as part of the oligomer component. Therefore, in an embodiment, the adhesion promoter comprises an oligomeric adhesion promoter, preferably one with urethane and acrylate groups. If used, the oligomeric urethane acrylate adhesion promoter preferably comprises at least 2 urethane groups, and is a reaction product of a monofunctional telechelic urethane acrylate oligomer comprising a telechelic hydroxyl group; preferably by reaction with an isocyanate silane adhesion promoter or a diisocyanate with an hydroxy, mercapto or amino functional silane.

One or more of the aforementioned additives can be employed in compositions according to the present invention in any suitable amount and may be chosen singly or in combination of one or more of the types enumerated herein. In a preferred embodiment, the additive component is present in an amount, relative to the entire weight of the composition, from about 0 wt. % to 40 wt. %, or from 0 wt. % to 30 wt. %, or from 0 wt. % to 20 wt. %, or from 0 wt. % to 10 wt. %, or from 0 wt. % to 5 wt. %; or from 0.01 wt. % to 40 wt. %; or from 0.01 wt. % to 30 wt. %, or from 0.01 wt. % to 20 wt. %, or from 0.01 wt. % to 10 wt. %, or from 0.01 wt. % to 5 wt. %, or from 0.1 wt. % to 2 wt. %. According to another embodiment, the additive component is present, relative to the weight of the entire radiation curable composition, from 1 wt. % to 40 wt. %, or from 1 wt. % to 30 wt. %, or from 1 wt. % to 20 wt. %, or from 1 wt. % to 10 wt. %, or from 1 wt. % to 5 wt. %.

As noted, compositions formulated according to various embodiments of the first aspect and formulations of the second aspect of the present invention may be configured to possess certain desirable characteristics. Specifically, such compositions and/or formulations may—in addition to possessing a low amount of volatile diluents—be capable of forming cured products having sufficiently low modulus values and/or which are fast-curing. This makes such coatings and/or formulations useful for optical fiber coating applications where microbend-caused attenuation resistance and high process speeds are desirable or even required. As used herein, a proxy for microbend-induced attenuation is storage modulus (G′). It is known that lower modulus primary coating compositions will, all else being equal, impart better resistance to microbend-induced attenuation. Furthermore, as used herein, a proxy for cure speed is the time that it takes a particular coating or formulation to reach 30% of its ultimate storage modulus value.

In various specific further embodiments, therefore, the optical fiber primary coating composition otherwise according to any of the embodiments of the first aspect, and/or the radiation curable formulation otherwise according to any of the embodiments of the second aspect, are configured to possess, when cured into a film according to the process and dimensions as specified elsewhere herein, a storage modulus (G′) of less than 600 kPa, or from 1 to 550 kPa, or from 10 to 500 kPa, or less than 300 kPa, or from 1 to 200 kPa, or from 10 to 150 kPa.

Furthermore, in various other specific further embodiments, the optical fiber primary coating composition otherwise according to any of the embodiments of the first aspect, and/or the radiation curable formulation otherwise according to any of the embodiments of the second aspect, are configured to possess, when cured into a film according to the process and dimensions as specified elsewhere herein, a time to reach 30% of the storage modulus increase of less than 1.2 seconds, or less than 1 second.

The compositions and/or formulations of the first and/or second aspect further preferably possess viscosity values that are suitable for use in the optical fiber application and curing process. In still other specific further embodiments, therefore, the optical fiber primary coating composition otherwise according to any of the embodiments of the first aspect, and/or the radiation curable formulation otherwise according to any of the embodiments of the second aspect, are configured to possess a viscosity of at least >0.1 Pascal seconds (Pas), or at least 0.2, or at least 0.5, or at least 1 Pa·s, and/or less than 15 Pa·s, or less than 12, or less than 10 Pa·s; or between 1 and 15 Pa·s, or between 2 and 12 Pa·s, or between 3 and 10 Pa·s, wherein viscosity is measured at 25° C. and a shear rate of 2500 s⁻¹.

A third aspect of the current invention is a method for coating an optical fiber, comprising providing a glass optical fiber, preferably by drawing a glass optical fiber through a draw tower; applying a primary coating composition onto the surface of the glass optical fiber; optionally, imparting a dose of UV light sufficient to at least partially cure said primary coating composition; applying a secondary coating composition to the primary coating composition; exposing the primary coating composition and the secondary coating composition to at least one radiation source capable of emitting ultraviolet radiation to affect curing of said primary coating composition and said secondary coating composition, to form a cured primary coating on the surface of the optical fiber, and a cured secondary coating on the surface of the cured primary coating; wherein the primary coating composition is a composition according to any of the embodiments of the first aspect or the second aspect of the current invention.

A fourth aspect of the current invention is a coated optical fiber, the coated optical fiber comprising a glass core and a cladding layer in contact with and surrounding said glass core; and a coating portion, said coating portion further including a primary coating layer in contact with and surrounding said cladding layer; and a secondary coating layer in contact with and surrounding said primary coating layer. According to this aspect, the primary coating layer is a cured product of a radiation curable composition according to any of the embodiments of the first aspect or the second aspect, and the primary and secondary coatings are applied and cured according to any of the embodiments of the third aspect.

According to an embodiment of the fourth aspect, the optical fiber comprises a core, a cladding, a primary coating contacting and surrounding the outer annular cladding region, and a secondary coating. According to some embodiments of the fourth aspect, the core comprises pure silica glass (SiO₂) or silica glass with one or more dopants that increase the index of refraction of the glass core relative to pure, undoped silica glass. Suitable dopants for increasing the index of refraction of the core include, without limitation, GeO₂, Al₂O₃, P₂O₅, TiO₂, ZrO₂, Nb₂O₅, Ta₂O₅, and/or combinations thereof.

The cladding layer may comprise pure silica glass (SiO₂), silica glass with one or more dopants which increase the index of refraction (e.g., GeO₂, Al₂O₃, P₂O₅, TiO₂, ZrO₂, Nb₂O₅ and/or Ta₂O₅), such as when the cladding is “up-doped,” or silica glass with a dopant which decreases the index of refraction, such as fluorine, such as when the inner cladding is “down-doped”, so long as the maximum relative refractive index [Δ_{1MAX}] of the core is greater than the maximum relative refractive index [Δ_{4MAX}] of the cladding. According to one embodiment, the cladding is also pure silica glass.

According to some embodiments of the fourth aspect, the primary coating is a typical primary coating that has an in-situ (or on-fiber) tensile modulus of less than 1.5 MPa, or less than 1.0 MPa, or less than 0.6 MPa, or less than 0.5 MPa, or less than 0.3 MPa, or from 0.15 to 0.8 MPa, and in other embodiments less than 0.2 MPa. Methods for describing in-situ modulus are well-known in the art and are described in, inter alia, U.S. Pat. Nos. 7,171,103 and 6,961,508, each of which is assigned to Covestro (Netherlands) B.V. In an embodiment, the cured primary coating has an in-situ glass transition temperature of less than −35° C., or less than −40° C., or less than −45° C., and in other embodiments not more than −50° C. A primary coating with a low in-situ modulus reduces the microbending which is the coupling mechanism between the modes propagating in the fiber. A low in-situ glass transition temperature ensures that the in-situ modulus of the primary coating will remain low even when the fiber is deployed in very cold environments.

The primary coating maintains adequate adhesion to the glass fiber during thermal and hydrolytic aging, yet (if needed) is capable of being strippable therefrom for splicing purposes. The primary coating typically has a thickness in the range of 20 to 50 μm (e.g., about 25 or 32.5 μm), thinner thickness in the range of 15 to 25 μm for 200 μm fibers. In other embodiments, the primary coating preferably has a thickness that is less than about 40 μm, more preferably between about 20 to about 40 μm, most preferably between about 20 to about 30 μm.

The secondary coating is in contact with and surrounds the primary coating. The secondary coating is, for example, the polymerization product of a coating composition whose molecules become highly crosslinked when polymerized. The secondary coating, according to an embodiment, may possess an in-situ tensile modulus of greater than 800 MPa, or greater than 1110 MPa, or greater than 1300 MPa, or greater than 1400 MPa, or greater than 1500 MPa. A secondary coating with a high in-situ modulus reduces the microbending which is the coupling mechanism between the modes propagating in the fiber.

According to other embodiments, the secondary coating has a high in-situ modulus (e.g., greater than about 800 MPa at 25° C.) and a high T_{g} (e.g., greater than about 50° C.). In other preferred embodiments, the in-situ secondary modulus is between about 1000 MPa and about 8000 MPa, more preferably between about 1200 MPa and about 5000 MPa, and most preferably between about 1500 MPa and about 3000 MPa. The in-situ T_{g} of the secondary coating is preferably between about 50° C. and about 120° C., more preferably between about 50° C. and about 100° C. In an embodiment, the secondary coating has a thickness that is less than about 40 μm, more preferably between about 20 to about 40 μm, most preferably between about 20 to about 30 μm.

Suitable materials for use in outer (or secondary) coating materials, as well as considerations related to selection of these materials, are well known in the art and are described in, for example, U.S. Pat. Nos. 4,962,992 and 5,104,433 to Chapin. As an alternative to these, high modulus coatings have also been obtained using low oligomer content coating systems, as described in U.S. Pat. No. 6,775,451 to Botelho et al., and U.S. Pat. No. 6,689,463 to Chou et al. In addition, non-reactive oligomer components have been used to achieve high modulus coatings, as described in U.S. Application Publ. No. 20070100039 to Schissel et al. The secondary coating may also include an ink, as is well known in the art. In such case, the secondary coating may be referred to as a “colored secondary coating.”

The coated optical fiber may alternatively comprise one or more additional layers disposed on the secondary layer. Most notably, such layers include a standalone “ink” layer which is applied and cured separately from the secondary coating. Other multi-layer coating systems are known and are disclosed in, e.g., WO2017173296.

It is known in the art how to formulate typical optical fiber coating for primary and secondary coatings for fiber as described above, as well as for ink and matrix materials for curing using broadband UV lamps. A good discussion of this technology and associated chemistry and test methods can be found in sections 4.6 to the end of chapter 4 in the textbook, “Specialty Optical Fibers Handbook” by A. Mendez and T. F. Morse, @ Elsevier Inc. 2007, published by Elsevier.

Any optical fiber type may be used in embodiments of the third aspect of present invention. In a preferred embodiment, however, the coated optical fiber possesses a mode-field diameter from 8 to 10 μm at a wavelength of 1310 nm, or a mode-field diameter from 9 to 13 μm at a wavelength of 1550 nm, and/or an effective area between 20 and 200 μm². Such fibers may be single mode and/or large-effective area fibers, given the expected demand for coating processes for these fibers that utilize higher line or processing speeds. However, other fiber types, such as multimode fibers, may be used as well.

A fifth aspect of the invention is an optical fiber cable, wherein the optical fiber comprises at least one optical fiber according to any of the embodiments of the fourth aspect of the invention, and/or wherein the optical fiber is the cured product of a composition according to the first or second aspect of the invention, and/or wherein the optical fiber was coated according to the third aspect of the invention.

Improved compositions (and the coated optical fibers produced therefrom) of the current invention can be formulated via the selection of components specified above herein, and further readily tuned by those of ordinary skill in the art to which this invention applies by following the formulation guidelines herein, as well as by extrapolating from the general approaches taken in the embodiments illustrated in the examples below. The following such examples further illustrate the invention but, of course, should not be construed as in any way limiting its scope.

### EXAMPLES

These examples illustrate embodiments of the instant invention. Table 1 describes the various components of the compositions used in the present examples. Table 2 describes the relative amounts of the reagents described in Table 1 which was used to synthesize the oligomers used in the present examples. Table 3 provides a summary of a further analysis of the oligomers so-characterized in Table 2, with the methods by which such oligomers were analyzed being described further herein, infra.

TABLE 1
Formulation Components

| | | Supplier/ |
|---|---|---|
| Component | Chemical Descriptor | Manufacturer |
| Lupranol 1100/1 | Bifunctional polypropylene glycol; molecular weight | Covestro |
| (PPG1000) | approximately 1000 | |
| Arcol PPG 2000 | Bifunctional polypropylene glycol; molecular weight | Covestro |
| (PPG2000) | approximately 2000 | |
| Acclaim 4200 | Bifunctional polypropylene glycol; molecular weight | Covestro |
| (PPG4000) | approximately 4000 | |
| Acclaim 8200 | Bifunctional polypropylene glycol; molecular weight | Covestro |
| (PPG8000) | approximately 8000 | |
| Acclaim 6320N | Trifunctional polypropylene glycol; molecular weight | Covestro |
| (PPG6000(triol)) | approximately 6000 | |
| GI-3000 | Bis hydroxy functional hydrogenated polybutadiene; | NIPPPON SODA |
| (HBP3000) | molecular weight approximately 3000 | |
| Oxymer M112 | Bis hydroxy functional polycarbonate; molecular | Perstorp |
| (PC1000) | weight approximately 1000 | |
| CAPA 2101A | Bis hydroxy functional polyester; molecular weight | Perstorp |
| (PE1000) | approximately 1000 | |
| DBP-C22 | α,Ω-bis hydroxy functional silicone; molecular weight | Gelest |
| (PDMS3000) | approximately 3000 | |
| TDI | Toluenediisocyanate; CAS 584-84-9 | Covestro, BASF |
| IPDI | Isophorone diisocyanate; CAS 4098-71-9 | |
| HEA | 2-hydroxyethyl acrylate; CAS 818-61-1 | Nippon Shokubai |
| HEMA | 2-hydroxyethyl methacrylate; CAS 868-77-9 | Nippon Shokubai |
| AMG | Glycerol acrylate methacrylate; CAS 433937-38-3 | TCI |
| KAoi | Isocyanato ethyl acrylate; CAS 13641-96-8 | TCI Europe |
| Acrylic acid | Acrylic acid; CAS 79-10-7 | Sigma-Aldrich |
| Acrylic | Acrylic anhydride; CAS 2051-76-5 | Sigma-Aldrich |
| anhydride | | |
| BHT | Butylated hydroxytoluene (food grade); CAS 000128- | Lanxess, BASF |
| | 37-0 | |
| DBTDL | Dibutyltin dilaurate; CAS 77-58-7 | Evonik |
| DMAP | 4-(Dimethylamino)pyridine; CAS 1122-58-3 | Sigma-Aldrich |
| Irganox 1520L | stabilizer, 4,6-bis (octylthiomethyl)-o-cresol; CAS | BASF |
| | 110553-27-0 | |
| BAPO | Irgacure 819, Phenylbis(2,4,6- | BASF |
| | trimethylbenzoyl)phosphine oxide; CAS 162881-26-7 | |
| AgiSyn 2880 | 2-(2-ethoxyethoxy)ethyl acrylate; used as reactive | Covestro |
| (EOEOA) | diluent monomer | |
| nVC | N-vinyl caprolactam; used as reactive diluent | Sigma-Aldrich |
| | monomer | |

### Synthesis of Oligomers 1-16

First, the reactor was purged with dry lean air. Then the specified amounts from Table 2 below of: first, (1) BHT (e.g., 1.28 parts for oligomer 1); then (2) the applicable isocyanate (e.g., 84.29 parts of TDI for oligomer 1), followed by (3) the acrylic acid (e.g. 0.08 parts for oligomer 1) were charged into a reactor (equipped with a stirrer, air inlet, dropping funnel, and condenser). After charging, the reactor was heated to 45° C. Then half of the specified DBTDL catalyst (e.g. DBTDL 0.06 g) followed by the hydroxyl-functional endcap (e.g. HEA, 56.08 parts in oligomer 1) were charged into the reactor whilst stirring. After waiting one (1) hour for the reaction to commence, the temperature was then raised to 60° C. At 60° C., the hydroxyl- or thiol-functional backbone component (e.g. HO-PPG₁₀₀₀-OH in 650.00 g per oligomer 1) and the second part of the catalyst (e.g. 0.07 g) were added after which the reaction temperature was raised to 85° C. then further maintained for two (2) additional hours.

After this two (2) additional hours of reaction time, the quantity of isocyanate (NCO) content was measured by a potentiometric titrator to ensure it was lower than 0.1% relative to the entire weight of the composition. If the isocyanate content was not lower than this value, the mixture was placed back in the reaction chamber in 15-minute additional increments (again at 85° C.) and checked again, with this step repeated until the isocyanate content fell to within the desired range. Finally, the resulting synthesized oligomer was cooled slowly and discharged for use in the experiments described elsewhere herein.

The resulting oligomer possessed an idealized structure as given in Table 2, Oligomer 1 possessed the following idealized structure (wherein “T” denotes the reaction product of the diisocyanate compound, “PPG1000” represents the reaction product of the polyol PPG1000, and “H-” represents the reaction product of the hydroxy-functional endcapper HEA):

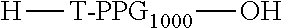

Note for oligomer 16: a one pot synthesis was applied resulting in 2 oligomers:

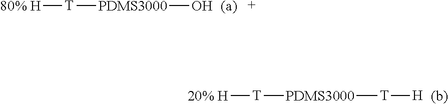

### Oligomer 17

First, a 500 ml reactor was purged with dry lean air. Then 0.5 parts of BHT, 0.03 parts of acrylic acid, and 300 parts of Acclaim 4200 were charged into a reactor (equipped with a stirrer, air inlet, dropping funnel, and condenser). After charging, the reactor was heated to 85° C. at which temperature 0.06 parts DBTDL were added. Next, 10.07 parts 2-isocyanato ethyl acrylate was added slowly whilst stirring and kept at 85° C. for an additional 2 hours, after which the NCO content was lower than 0.1%.

The resulting oligomer possessed an idealized structure as follows (wherein “A” denotes an acrylate group (i.e. CH₂CHCO₂)) with 1 urethane group:

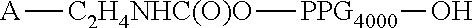

### Oligomer 18

A 500 ml reactor (equipped with a stirrer, air inlet, dropping funnel, and condenser) was charged with 100 g of Acclaim PPG4200, 0.26 g 4-(Dimethylamino)pyridine and 150 ml of THF. Next, 2.73 g of acrylic anhydride was added slowly whilst stirring. After stirring for 40 hours at room temperature, the THF was evaporated using a rotavap, 50 mol dichloromethane was added and the reaction mixture was washed with a saturated aqueous Na₂CO₃ solution and water respectively. After drying over Na₂SO₄, filtration and evaporation of the dichloromethane oligomer 18 was obtained having the following idealized structure (wherein “A” denotes an acrylate group (i.e. CH₂CHCO₂)) with 0 urethane group:

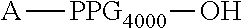

### Oligomer 19

This oligomer was prepared as described in WO2021021971 (oligomer 1 in WO2021021971), using 95.32 parts of Acclaim 6320N, 6.15 parts of HEA, 503 parts of Acclaim 8200 N, 18.97 parts of TDI, 0.3 parts of DBTDL, 0.824 parts of BHT, 0.29 parts of acrylic acid, and 190.4 parts of SR489D. The idealized structure was as follows (wherein “T” denotes the reaction product of the diisocyanate compound TDI, “—H” represents the reaction product of the hydroxy-functional endcapper HEA, and “PPG₆₀₀₀(triol)” represents the reaction product of the polyol Acclaim 6320N):

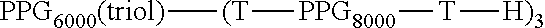

The oligomer possessed 12 urethane groups.

### Oligomer 20

First, the reactor was purged with dry lean air. Then 0.28 g of BHT, 150.77 g of oligomer 3 (H-T-PPG4000-OH), and 0.02 g of acrylic acid were charged into a reactor (equipped with a stirrer, air inlet, dropping funnel, and condenser). After charging, the reactor was heated to 75° C. Then, 0.03 g of DBTDL was added, followed by 8.65 g of 3-(triethoxysilyl) propyl isocyanate, after which the mixture was stirred for 2 additional hours. After this two (2) additional hours of reaction time, the quantity of isocyanate (NCO) content was measured by a potentiometric titrator to ensure it was lower than 0.1% relative to the entire weight of the composition. If the isocyanate content was not lower than this value, the mixture was placed back in the reaction chamber in 30-minute additional increments (again at 85° C.) and checked again, with this step repeated until the isocyanate content fell to within the desired range. Finally, the resulting synthesized oligomer was cooled slowly and discharged for use in the experiments described elsewhere herein. The resulting oligomer possessed the following idealized structure (wherein “T” denotes the reaction product of the diisocyanate compound, and “H-” represents the reaction product of the hydroxy-functional endcapper HEA) with 3 urethane groups:

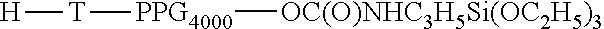

### Oligomer 21

This oligomer was synthesized in a fashion identical to the preceding oligomer 20, except that instantly, 138.87 g of oligomer 17 (A-C₂H₄NHC(O)O-PPG₄₀₀₀-OH) and 7.3 g 3-(Triethoxysilyl) propyl isocyanate were utilized. The resulting oligomer possessed the following idealized structure (wherein “A” denotes an acrylate group (i.e. CH₂CHCO₂)) with 2 urethane groups:

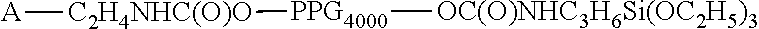

TABLE 2
Oligomer synthesis

| | | | | Hydroxyl- | | Hydroxy- | | | | | Number |
|---|---|---|---|---|---|---|---|---|---|---|---|
| | | Iso- | | functional | | or thiol- | | | | | of |
| Olig- | | cyanate | Amount | endcapper | Amount | functional | Amount | | | Acrylic | urethane |
| omer | Ideal structure | (ii) | (g) | (iii) | (g) | backbone (i) | (g) | DBTDL | BHT | Acid | groups |
| 1 | H-T-PPG₁₀₀₀-OH | TDI | 84.29 | HEA | 56.08 | HO-PPG₁₀₀₀-OH | 650.00 | 0.13 | 1.28 | 0.08 | 2 |
| 2 | H-T-PPG₂₀₀₀-OH | TDI | 53.31 | HEA | 35.56 | HO-PPG₂₀₀₀-OH | 710.00 | 0.13 | 1.28 | 0.08 | 2 |
| 3 | H-T-PPG₄₀₀₀-OH | TDI | 28.26 | HEA | 18.86 | HO-PPG₄₀₀₀-OH | 750.70 | 0.15 | 1.28 | 0.08 | 2 |
| 4 | H-T-PPG₈₀₀₀-OH | TDI | 14.19 | HEA | 9.46 | HO-PPG₈₀₀₀-OH | 750.10 | 0.15 | 1.26 | 0.08 | 2 |
| 5 | HEMA-T-PPG₄₀₀₀-OH | TDI | 22.61 | HEMA | 16.89 | HO-PPG₄₀₀₀-OH | 600.10 | 0.12 | 1.03 | 0.07 | 2 |
| 6 | AMG-T-PPG₄₀₀₀-OH | TDI | 22.62 | AMG | 27.81 | HO-PPG₄₀₀₀-OH | 600.00 | 0.12 | 1.04 | 0.07 | 2 |
| 7 | CapA-T-PPG₄₀₀₀-OH | TDI | 15.08 | CapA | 29.68 | HO-PPG₄₀₀₀-OH | 400.00 | 0.09 | 0.72 | 0.04 | 2 |
| 8 | H-T-PE₁₀₀₀-OH | TDI | 26.65 | HEA | 17.78 | HO-PE₁₀₀₀-OH | 150.05 | 0.04 | 0.33 | 0.02 | 2 |
| 9 | H-T-HPB₃₀₀₀-OH | TDI | 4.29 | HEA | 2.91 | HO-HPB₃₀₀₀-OH | 100.00 | 0.02 | 0.18 | 0.01 | 2 |
| 10 | H-I-PC₁₀₀₀-OH | IPDI (I) | 40.37 | HEA | 21.10 | HO-PC₁₀₀₀-OH | 200.00 | 0.06 | 0.42 | 0.02 | 2 |
| 11 | H-T-PPG₁₀₀₀-T-H | TDI | 142.95 | HEA | 95.42 | HO-PPG₁₀₀₀-OH | 550.00 | 0.16 | 1.28 | 0.08 | 4 |
| 12 | H-T-PPG₂₀₀₀-T-H | TDI | 97.54 | HEA | 65.18 | HO-PPG₂₀₀₀-OH | 650.30 | 0.19 | 2.00 | 0.03 | 4 |
| 13 | H-T-PPG₄₀₀₀-T-H | TDI | 52.76 | HEA | 35.43 | HO-PPG₄₀₀₀-OH | 700.00 | 0.19 | 2.19 | 0.02 | 4 |
| 14 | H-T-PPG₈₀₀₀-T-H | TDI | 31.5 | HEA | 21.00 | HO-PPG₈₀₀₀-OH | 746.00 | 0.13 | 1.3 | 0.02 | 4 |
| 15 | HEMA-T-PPG₄₀₀₀-T-HEMA | TDI | 41.47 | HEMA | 31.02 | HO-PPG₄₀₀₀-OH | 550.31 | 0.14 | 1.02 | 0.06 | 4 |
| 16 | 20 H-T-PDMS₃₀₀₀-T-H, | TDI | 4.39 | HEA | 2.99 | HO-PDMS₃₀₀₀-OH | 99.91 | 0.02 | 0.17 | 0.01 | 20% 4 |
| | 80 H-T-PDMS₃₀₀₀-OH | | | | | | | | | | 80% 2 |

| | | |
|---|---|---|
| 17 | A-C₂H₄NHC(O)O- | Described above |
| | PPG₄₀₀₀-OH | |
| 18 | A-PPG₄₀₀₀-OH | Described above |
| 19 | PPG₆₀₀₀(triol)- | Described above |
| | (T-PPG₈₀₀₀-T-H)₃ | |
| 20 | H-T-PPG₄₀₀₀- | Described above |
| | OC(O)NHC₃H₅Si(OC₂H₅)₃ | |
| 21 | A-C₂H₄NHC(O)O-PPG₄₀₀₀- | Described above |
| | OC(O)NHC₃H₅Si(OC₂H₅)₃ | |

TABLE 3
Further oligomer characterization
Unless otherwise specified, all units are in kilodaltons.

| | | Mn Theo | | | | dn/dc | Tg onset | Tg midpoint |
|---|---|---|---|---|---|---|---|---|
| Oligomer | Ideal structure | (g/mol) | Mn | Mw | Mz | (mL/g) | (° C.) | (° C.) |
| 1 | H-T-PPG₁₀₀₀-OH | 1290 | 2.1 | 2.4 | 3.1 | 0.0638 | −58.1 | −55.1 |
| 2 | H-T-PPG₂₀₀₀-OH | 2290 | 2.8 | 3.3 | 4.2 | 0.0578 | −62.7 | −60.3 |
| 3 | H-T-PPG₄₀₀₀-OH | 4290 | 6.6 | 7.9 | 11.5 | 0.0507 | −66.0 | −64.5 |
| 4 | H-T-PPG₈₀₀₀-OH | 8290 | 9.7 | 11.5 | 14.0 | 0.0490 | −67.7 | −66.4 |
| 5 | HEMA-T-PPG₄₀₀₀-OH | 4304 | 5.2 | 6.2 | 8.2 | 0.0532 | −66.1 | −64.3 |
| 6 | AMG-T-PPG₄₀₀₀-OH | 4388 | 6.5 | 8.5 | 17.1 | 0.0512 | −65.4 | −63.7 |
| 7 | CapA-T-PPG₄₀₀₀-OH | 4519 | 5.1 | 5.9 | 6.9 | 0.0542 | −66.1 | −64.8 |
| 8 | H-T-PE₁₀₀₀-OH | 1290 | 1.7 | 2.0 | 2.3 | 0.0843 | −52.3 | −49.4 |
| 9 | H-T-HPB₃₀₀₀-OH | 3290 | 4.8 | 7.6 | 23.7 | 0.0809 | −39.3 | −36.9 |
| 10 | H-I-PC₁₀₀₀-OH | 1290 | 1.7 | 2.2 | 2.9 | 0.0710 | −11.6 | −8.4 |
| 11 | H-T-PPG₁₀₀₀-T-H | 1580 | 2.0 | 2.6 | 3.7 | 0.0754 | −40.2 | −36.5 |
| 12 | H-T-PPG₂₀₀₀-T-H | 2580 | 2657 | 3.3 | 3.9 | 0.0659 | −53.2 | −49.5 |
| 13 | H-T-PPG₄₀₀₀-T-H | 4580 | 7516 | 8.8 | 11.5 | 0.0551 | −61.0 | −59.0 |
| 14 | H-T-PPG₈₀₀₀-T-H | 8580 | 12760 | 16.1 | 21.3 | 0.0517 | −64.9 | −63.3 |
| 15 | HEMA-T-PPG₄₀₀₀-T-HEMA | 4608 | 5633 | 6.8 | 8.1 | 0.0550 | −60.8 | −58.8 |
| 16 | 20 H-T-PDMS₃₀₀₀-T-H, | 3580, 3290 | 3920 | 4.5 | 6.1 | 0.0474 | <−70 | |
| | 80 H-T-PDMS₃₀₀₀-OH | | | | | | | |
| 17 | A-C₂H₄NHC(O)O-PPG₄₀₀₀-OH | 4141 | 4685 | 5.7 | 9.1 | 0.0477 | −68.1 | −67.0 |
| 18 | A-PPG₄₀₀₀-OH | 4056 | 5298 | 5.9 | 8.3 | 0.0465 | −69.8 | −69.3 |
| 19 | PPG₆₀₀₀(triol)-(T-PPG₈₀₀₀-T-H)₃ | 31392 | 29440 | 68.3 | 13.2 | 0.0518 | <−70 | |
| 20 | H-T-PPG₄₀₀₀-OC(O)NHC₃H₅Si(OC₂H₅)₃ | 4537 | 6782 | 11.4 | 39.5 | 0.0508 | −65.3 | −63.8 |
| 21 | A-C₂H₄NHC(O)O-PPG₄₀₀₀- | 4388 | 4987 | 10.1 | 47.6 | 0.0475 | −67.6 | −66.8 |
| | OC(O)NHC₃H₅Si(OC₂H₅)₃ | | | | | | | |

### SEC Characterization

With the various reactive oligomers having been synthesized, they were then evaluated according to the size exclusion chromatography (SEC) method in accordance with ASTM: D5296-11: “Standard Test Method for Molecular Weight Averages and Molecular Weight Distribution of Polystyrene by High Performance Size-Exclusion Chromatography,” ASTM International, West Conshohocken, PA, (2011). Additionally, ASTM norm D 5226-98: “Standard Practice for Dissolving Polymer Materials,” ASTM International, West Conshohocken, PA, (2010), was used to facilitate the definition of solvents which are appropriate for polymer analysis.

Specifically, all Size Exclusion Chromatography measurements were performed Waters APC (Advanced Polymer Chromatography) system with RI detector, a Wyatt microDawn multi-angle light scattering instrument and a Wyatt micro ViscoStar capillary-bridge differential viscometer. For chromatographic separation, a column: 4.6×76 mm, Acquity APC XT 450 2.5 μm, 125 2.5 μm, 45 1.7 μm was used. Detectors and columns were operated at 40° C. Prior to conducting SEC, each respective polymer was dissolved at a concentration ranging from 1.0 to 1.5 mg/ml in tetrahydrofuran (THF) containing 1 wt. % of acetic acid. This THE solution was also used as an eluent in SEC analysis at a flow rate of 0.5 ml/min.

With the dissolution complete, the molar mass and molar mass distribution were then determined with the above-referenced triple detection method using the refractive index, differential viscosity and right-angle light scattering signals. For a calculation of molecular weight averages and molar mass distribution, a refractive index increment (dn/dc) of around 0.07 ml/g was used. Specifically, the dn/dc values for Oligomers 1-21 were determined accordingly and are reported in Table 3 herein in units of milliliters per gram. The refractive index increment and molecular mass averages, as well as the molar mass distributions were determined by integration of the whole refractive index chromatograms. An IV-DP signal was additionally used to set the integration limit. Recoveries of the samples from columns varied between 95 and 105%, which are the typical of values obtained in size-exclusion chromatography.

Using the above-prescribed method, values for Mn, Mw, Mz, and dn/dc were recorded and reported.

### Oligomer Tg

The glass transition temperature (T_{g}) of the synthesized oligomers were determined on a Mettler Toledo DSC3+ Differential Scanning calorimeter. A temperature range from −80° C. to 80° C. was employed. Consequently, only T_{g} values higher than −70° C. could be determined reliably. Evaluation was performed with Stare software in the 1^{st} derivative of the second heating curve using a heating rate of 10° C./min.

### Formulations 1-44

Each of the formulations described in Table 4 below were prepared by conventional methods by using a 50 ml mixing cup suitable for use with a Speedmixer™. Specifically, 1 part by weight of the photoinitiator BAPO and 0.25 parts of Irganox 1520 L were added to the amount of components specified in Tables 4 below, resulting in 10 g in total for each formulation. The cup was then closed and vigorously mixed in a Speedmixer™ DAC150FVZ for 30 seconds, stopped, and mixed again for 30 additional seconds via the same method.

These samples were tested according to the methods described below for determining each formulation's viscosity, the T_{30%, modulus max}, and Max. G′, respectively. Values for viscosity are reported in pascal seconds (Pas) rounded to two decimal places, whereas T_{30%, modulus max}, is presented in seconds, also rounded to two decimal places. Max G′ is reported in kilo Pascals (kPa), rounded to the nearest whole unit. Values for these measured characteristics are reported in Table 4 below.

### Viscosity

Viscosity of the formulations were determined on a Brookfield CAP 1000 at 750 rpm and recorded after 30 seconds. The measurements were performed in triplicate (the average of which is denoted in Table 4 below) at 25° C. and a shear rate of 2500 s⁻¹.

### Determination of Maximum Modulus (G′) and T_{30%, Modulus Max} Values

Values for Maximum Modulus (G′) were determined according to the following procedure described herein. The hardware/equipment used in this procedure was as follows:

### Rheometer+accessories

ARESG2-rheometer (manufacturer: TA Instruments)
APS temperature control device (Advanced Peltier System)
APS Standard Flat Plate (lower geometry)
ARESG2 UV-curing Accessory (upper plate fixture, UV-light shield back & access door, collimating optic lens)
Ø20 mm acrylic plate with the UV-curing Option upper plate fixture (upper geometry)
Silverline UV radiometer, UV-light sensor (non-calibrated), UV-sensor geometry and disposable plate holder

### UV-Light Source & Other

Omnicure LX500 in combination with 385 nm LED and 8 mm lens attached
Moeller Easy 412-DC-TC Control Relay (trigger box)
UV Power Puck II (Electronic Instrumentation & Technology, calibrated)

The hardware described above was then set-up and arranged according to the following. First, UV-curing measurements were performed on the ARESG2 rheometer (TA Instruments). The rheometer was equipped with the APS temperature control device, the APS Standard Flat Plate as lower geometry and the ARESG2 UV-curing Option. The upper geometry used was the upper plate fixture from the ARESG2 UV-curing Option in combination with a 20 mm diameter acrylic plate. As the UV-light source, the Omnicure LX500 spot curing system was used in combination with 385 nm LED (8 mm lens). The 385 nm LED was then inserted into the collimating optic lens of the ARES G2 UV-curing accessory. The collimating lens was fixed to the light shield and aligned to the upper UV geometry mirror and the alignment screws were tightened. The diameter of the original 5 mm lightguide holder part of the collimating lens was increased to 12 mm in order to accommodate the 385 nm UV-LED.

Then, the Omnicure LX500 spot curing system was connected via a Moeller Easy 412-DC-TC Control Relay to the DIGITAL I/O connector at the ARESG2. The Control Relay served as a trigger-box for the UV-light source. The delay time of the trigger was set to 1.5 seconds, meaning that the 385 nm UV-LED was automatically switched on with a delay of 1.5 seconds after the start of the data collection of the modulus measurement on the ARESG2. The light intensity was set to 95%, and the duration of the UV-light was fixed to 128 seconds.

Alignment of the UV-light: Alignment was performed prior to installation of the APS temperature control unit. The UV sensor geometry was attached to a disposable plate holder and installed as the lower geometry. The UV-light sensor, which was connected to Silverline UV-radiometer, was positioned in the outer hole of the UV sensor geometry. The upper geometry was positioned on top of the UV-light sensor by applying approximately 100 grams of axial force. Then, the light intensity was measured at four locations by rotating the lower geometry approximately 90° between each successive measurement. In order to achieve a light distribution at each point which was as equal as possible, the alignment of the collimating lens was then adjusted with the alignment screws on the light shield. The difference in light intensity at the four different positions was maintained to below 10%.

Determination of Light Intensity: Prior to the RT-DMA measurements, the UV-intensity was measured with help of a calibrated UV Power Puck II. To achieve this, the sensor of the UV Power Puck II was positioned directly below the surface of the 20 mm acrylic plate in the upper plate fixture (distance <0.5 mm) with the surface of the acrylic plate completely covering the sensor surface. Next, the Omnicure LX500 UV-source (with an intensity value set to 95%) was manually switched on for 10 seconds. During this 10 second interval, the UVA2 intensity (i.e. radiation between wavelengths of 380-410 nm) was measured with the UV Power Puck II instrument. The measured UVA2 intensity was determined to be between 60-70 mW/cm², with an actual value of 67 mW/cm² recorded.

Determination of the actual delay time: When starting a measurement, there was a delay between the start of data sampling and the start of UV-illumination. In the settings of the Moeller Easy 412-DC-TC Control Relay, the delay was set to 1.5 seconds, which signifies that the UV-illumination began 1.5 seconds after the initiation of data sampling.

With help of a Light Dependent Resistance (LDR) and an oscilloscope (PicoScope 3424) an actual delay time of 1.519 s was measured. The delay time of 1.519 seconds was the measured average value of 10 individual measurements with a standard deviation of 0.004 seconds.

RT-DMA measurement: The RT-DMA UV-curing measurements were then performed using an ARESG2 rheometer paired with the Advanced Peltier System as a temperature control device, the APS Flat Plate, and the ARESG2 UV-curing Accessory set up. A 385 nm LED with an 8-mm lens connected to the Omnicure LX500 was used as the UV light source.

Sample loading: Prior to loading each respective sample, the temperature of the bottom plate was set to 50° C. When the temperature reached 50° C., the surface of the upper plate (which was an acrylic plate with a thickness of 20 mm) was brought into contact (i.e. a gap of 0 mm with the lower plate by applying an axial force of between 200-400 grams, thereby allowing the upper parallel plate to equilibrate to the set temperature of 50° C. The system was allowed to further equilibrate its temperature for at least 5 minutes after initial contact. Next, a zero-fixture procedure was performed according to well-known methods to determine the gap=0 position. After determining the gap=0 position, the upper plate was moved to a position of 10 mm away. Then a portion of each respective sample was transferred to the center of the lower plate with the tip of a small spatula, after which the upper geometry was lowered to a gap=0.120 mm position. The quantity of the sample had to be sufficient to ensure than an excess would be pushed outside of the gap covering the entire circumference of the upper parallel plate after the upper geometry was brought down to the reduced gap. Next, the excess of sample that had been displaced outside of the gap was removed, and the upper geometry was brought down further to the measuring position (having a gap=0.100 mm). With the measuring position loaded, the temperature of the sample was allowed to equilibrate to 50° C. Finally, when the sample temperature was measured as stable between 49.9° and 50.10° C., the measurement process would commence by activating the trigger box (Moeller Easy 412-DC-TC) and using the interface and interconnection provided by the TRIOS software package.

Measurement: The actual UV cure RT-DMA measurement was a so-called “fast sampling” measurement taken at 50° C. That is, it was an oscillation fast sampling taken at 50° C. for a duration of 128 seconds, with a 1% strain, a rotational velocity of 52.36 rad/s, and a measurement frequency of 50 points per second (i.e. 0.020 seconds between each successive measurement point).

Then, the measurement was started via the start button in the TRIOS software. Once the data sampling started, the rheometer sent a signal to the control relay, which in turn activated the Omnicure LX500 UV-light source to illuminate the respective sample with the aforementioned delay of 1.519 s after commencement of data sampling. The sample was illuminated with the 385 nm UV-light (Intensity 60-70 mW/cm²) during 128 seconds of fast sampling data collection as described above. After the measurement was finished, the TRIOS data file was exported to Microsoft Excel. Then the sample was removed and the plates subsequently cleaned thoroughly with ethanol prior to loading of the next sample.

Data analysis: As mentioned, the TRIOS data was exported to Microsoft Excel. Excel was used to plot graphs and calculate various parameters for characterization of the cure speed performance of the tested formulations as described below. The graphs included those corresponding to storage modulus (G′) as a function of UV-time (UV-time was calculated by subtracting the delay time (1.519 s) from the actual time for each individual data point), and relative storage modulus (rel G′) as function of UV-time (rel G′ was calculated by the quotient of the measured G′ value at certain UV-time and the maximum obtained G′ value during the cure measurement). The maximum value observed of the graph of the G′ graph was determined by taking the average of the G′ value between 110 and 120 seconds, and is reported in Table 4 below under the column headed by “Max. G′”. For samples that did not fully cure during the testing time, this column is indicated with the designation “NFC,” indicating a Max. G′ was not attainable given the test procedure and time limits employed.

The characteristic parameters, meanwhile, included: (1) the time to reach 30% of the total storage modulus (G′) increase, and (2) average G′ 110-120 s (Average storage modulus value out of 6 datapoints towards the end of the cure measurement). The results for (1) of each formulation is reported in Table 4 below under the column headed by T_{30%, modulus max}.

TABLE 4
All amounts in parts by weight.

| | | | Component 2 | | | | | T_{30%,} | |
|---|---|---|---|---|---|---|---|---|---|
| | | | (oligomer | | Component 3 | | | _{modulus} | Max |
| Formulation | Component 1 | Amt. | (a)) | Amt | (and 4) | Amt | Viscosity | ₘₐₓ | G′ |
| 1 | Oligomer 13 | 90 | | | EOEOA | 10 | 3.62 | 0.42 | 678 |
| 2 | Oligomer 13 | 80 | | | EOEOA | 20 | 1.67 | 0.50 | 523 |
| 3 | Oligomer 13 | 70 | | | EOEOA | 30 | 0.73 | 0.58 | 481 |
| 4 | Oligomer 13 | 30 | | | EOEOA | 70 | 0.03 | 1.24 | 166 |
| 5 | Oligomer 13 | 20 | | | EOEOA | 80 | <0.02 | 1.49 | 117 |
| 6 | Oligomer 13 | 10 | | | EOEOA | 90 | <0.02 | 1.68 | 102 |
| 7 | Oligomer 13 | 100 | | | | | 9.07 | 0.37 | 624 |
| 8 | Oligomer 13 | 90 | Oligomer 3 | 10 | | | 8.28 | 0.39 | 539 |
| 9 | Oligomer 13 | 80 | Oligomer 3 | 20 | | | 7.48 | 0.40 | 460 |
| 10 | Oligomer 13 | 70 | Oligomer 3 | 30 | | | 6.82 | 0.40 | 414 |
| 11 | Oligomer 13 | 60 | Oligomer 3 | 40 | | | 6.19 | 0.44 | 297 |
| 12 | Oligomer 13 | 50 | Oligomer 3 | 50 | | | 5.59 | 0.44 | 270 |
| 13 | Oligomer 13 | 40 | Oligomer 3 | 60 | | | 5.05 | 0.43 | 234 |
| 14 | Oligomer 13 | 30 | Oligomer 3 | 70 | | | 4.51 | 0.44 | 172 |
| 15 | Oligomer 13 | 20 | Oligomer 3 | 80 | | | 4.14 | 0.45 | 126 |
| 16 | Oligomer 13 | 10 | Oligomer 3 | 90 | | | 3.46 | 0.49 | 78 |
| 17 | Oligomer 11 | 10 | Oligomer 3 | 90 | | | 3.79 | 0.46 | 64 |
| 18 | Oligomer 12 | 10 | Oligomer 3 | 90 | | | 3.43 | 0.46 | 65 |
| 19 | Oligomer 14 | 10 | Oligomer 3 | 90 | | | 4.08 | 0.50 | 60 |
| 20 | Oligomer 20 | 10 | Oligomer 3 | 90 | | | 4.26 | 0.69 | 35 |
| 21 | Oligomer 13 | 10 | Oligomer 1 | 90 | | | 2.98 | 0.40 | 215 |
| 22 | Oligomer 13 | 10 | Oligomer 2 | 90 | | | 2.77 | 0.40 | 190 |
| 23 | Oligomer 13 | 10 | Oligomer 3 | 90 | | | 3.46 | 0.49 | 78 |
| 24 | Oligomer 13 | 10 | Oligomer 4 | 90 | | | 7.28 | 0.56 | 31 |
| 25 | Oligomer 15 | 10 | Oligomer 3 | 90 | | | 3.47 | 0.66 | 53 |
| 26 | Oligomer 13 | 10 | Oligomer 8 | 90 | | | >10 | 0.41 | 540 |
| 27 | Oligomer 13 | 10 | Oligomer 9 | 90 | | | >10 | 0.81 | 85 |
| 28 | Oligomer 13 | 10 | Oligomer 10 | 90 | | | >10 | 2.03 | 424 |
| 29 | Oligomer 16 | 100 | | | | | Unable to | 0.43 | 7 |
| | | | | | | | measure | | |
| 30 | Oligomer 13 | 10 | Oligomer 5 | 90 | | | 3.71 | 2.98 | 48 |
| 31 | Oligomer 13 | 10 | Oligomer 6 | 90 | | | 4.57 | 0.63 | 139 |
| 32 | Oligomer 13 | 10 | Oligomer 7 | 90 | | | 4.11 | 0.80 | 43 |
| 33 | Oligomer 13 | 10 | Oligomer 17 | 90 | | | 1.83 | 0.70 | 130 |
| 34 | Oligomer 13 | 10 | Oligomer 18 | 90 | | | 1.44 | 1.11 | 429 |
| 35 | Oligomer 14 | 5 | Oligomer 4 | 80 | EOEOA | 15 | 2.26 | 1.01 | 21 |
| 36 | Oligomer 14 | 5 | Oligomer 4 | 80 | DMA | 15 | 1.89 | 0.49 | 121 |
| 37 | Oligomer 14 | 10 | Oligomer 4 | 80 | DMA | 10 | 2.83 | 0.42 | 86 |
| 38 | Oligomer 19 | 5 | Oligomer 4 | 80 | EOEOA | 15 | 2.38 | 1.08 | 15 |
| 39 | Oligomer 13 | 10 | Oligomer 3 | 89 | nVC | 1 | 3.18 | 0.36 | 98 |
| 40 | Oligomer 13 | 10 | Oligomer 3 | 85 | nVC | 5 | 2.5 | 0.22 | 109 |
| 41 | Oligomer 13 | 10 | Oligomer 3 | 70 | EOEOA | 19 | 0.8 | 0.64 | 78 |
| | | | | | nVC | 1 | | | |
| 42 | Oligomer 13 | 10 | Oligomer 3 | 70 | EOEOA | 15 | 0.84 | 0.36 | 85 |
| | | | | | nVC | 5 | | | |
| 43 | Oligomer 13 | 10 | Oligomer 3 | 70 | Oligomer 20 | 20 | 4.07 | 0.47 | 100 |
| 44 | Oligomer 13 | 10 | Oligomer 3 | 70 | Oligomer 21 | 20 | 3.37 | 0.50 | 107 |

### Discussion of Results

As can be seen, compositions according to various aspects of the present invention tend to possess properties which would make them especially suitable for use in optical fiber coating applications, and in particular as optical fiber primary coatings. First of all, it will be apparent that compositions possessing low or no amounts of reactive diluents (EOEOA, DMA, and/or nVC are used in the examples above) are—all else being equal—more preferred for use in optical fiber coating applications in that the volatile content is minimized.

Further, it is shown that compositions having such low volatile content are capable of being configured in a variety of different ways so as to exhibit further suitability for use in optical fiber coating applications, especially in terms of cure speed (as measured by low T_{30%, modulus max} values, especially those below 1.2 seconds, more preferably below 1.0 seconds), low modulus (as measured by low G′ values, especially those below 600 kPa, more preferably below 500 kPa, more preferably lower than 400 kPa, more preferably below 300 kPa), and/or low viscosity (especially those below 9 pascal seconds, more preferably below 5 pascal seconds).

The aforementioned effect(s) are demonstrated using a variety of oligomer types, quantities, combinations, and diluents.

Unless otherwise specified, the term wt. % means the amount by mass of a particular constituent relative to the entire liquid radiation curable composition into which it is incorporated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While the invention has been described in detail and with reference to specific embodiments thereof, it will be apparent to one of ordinary skill in the art that various changes and modifications can be made therein without departing from the spirit and scope of the claimed invention.

1: A radiation curable formulation characterized in that the formulation comprises:
(a) one or more monofunctional telechelic (meth)acrylate oligomers with 0-5 urethane groups, or 0-3 urethane groups, and a number average molecular weight (Mn) from 750-20000 g/mol, wherein the one or more monofunctional telechelic (meth)acrylate oligomers according to (a) further comprises a telechelic hydroxyl group;
(b) one or more di- or trifunctional telechelic urethane (meth)acrylate oligomers with at least 4 urethane groups and an Mn from 750-100000 g/mol;
wherein a molar ratio of (b) to (a) is from 0.01 to 1.5;
(c) optionally, one or more reactive diluent monomer with an Mn of less than 500 g/mol;
(d) one or more photoinitiator; and
(e) optionally, one or more additives comprising an adhesion promoter and/or a stabilizer.

2: The radiation curable formulation according to claim 1 in which the Mn of the one or more di- or trifunctional telechelic urethane acrylate oligomers with at least 4 urethane groups (b) is at least 1000 g/mol, or at least 1250 g/mol, or at least 1500 g/mol, and/or wherein the Mn of (b) is 60,000 g/mol or less, or 40,000 g/mol or less, or 30,000 g/mol or less, or between 1000 to 20,000 g/mol, or between 1500 to 15,000 g/mol.

3: The radiation curable formulation of claim 1, wherein the one or more di- or trifunctional telechelic urethane acrylate oligomers (b) is a polyether oligomer.

4: The radiation curable formulation of claim 1, wherein the Mn of the one or more monofunctional telechelic (meth)acrylate oligomers with 0-5 urethane groups (a) is at least 1000 g/mol, or at least 1250 g/mol, or at least 1500 g/mol, and/or at most 18,000 g/mol, or at most 16,000 g/mol, or at most 15,000 g/mol.

5: The radiation curable formulation of claim 1, wherein the one or more monofunctional telechelic (meth)acrylate oligomers according to (a) possesses from 1-3 urethane groups.

6: The radiation curable formulation of claim 1, wherein the one or more monofunctional telechelic (meth)acrylate oligomers according to (a) is a polyether oligomer.

7: The radiation curable formulation of claim 1, wherein the molar ratio of (b) to (a) is greater than 0.02, or greater than 0.04, or greater than 0.06 and/or less than 1.2, or less than 1.0, or less than 0.8, or less than 0.6.

8: The radiation curable formulation of claim 1, wherein (b) and (a) are present in an amount of at least 60 wt. %, or at least 65 wt. %, or at least 70 wt. %, or at least 80 wt. %, or at least 90 wt. %, or at least 95 wt. %, or at least 99 wt. %, relative to the weight of the entire composition.

9: The radiation curable formulation of claim 1, wherein the one or more reactive diluent monomer (c) is present in an amount, relative to the weight of the entire composition, in an amount of less than 40 wt. %, or less than 30 wt. %, or less than 20 wt. %, or less than 10 wt. %, or less than 5 wt. %.

10: The radiation curable formulation of claim 1, wherein (c) comprises an N-vinyl amide.

11: The radiation curable formulation of claim 1, wherein the composition further comprises an oligomeric adhesion promoter.

12: The radiation curable formulation of claim 1, wherein the oligomeric adhesion promoter comprises at least 2 urethane groups.

13: The radiation curable formulation of claim 11, wherein the oligomeric adhesion promoter is a reaction product of a monofunctional telechelic urethane acrylate oligomer comprising a telechelic hydroxyl group.

14: The radiation curable formulation of claim 1, wherein (d) is present in an amount, relative to the weight of the entire composition, of from 0.05-5 wt. %.

15: The radiation curable formulation of claim 1, wherein stabilizer is present, relative to the weight of the entire composition, in amount of from 0.05-2 wt. %.

16: The radiation curable formulation of claim 1, wherein viscosity of the formulation is
at least >0.1 Pascal seconds (Pa·s), or at least 0.2, or at least 0.5, or at least 1 Pa·s, and/or less than 15 Pa·s, or less than 12, or less than 10 Pa·s; or between 1 and 15 Pa·s, or between 2 and 12 Pa·s, or between 3 and 10 Pa·s,
wherein viscosity is measured at 25° C. and a shear rate of 2500 s⁻¹.

17: A cured film comprising the radiation curable formulation of claim 1, wherein, the film possesses a storage modulus (G′) of less than 600 kPa, or from 1 to 550 kPa, or from 10 to 500 kPa, or of less than 300 kPa, or from 1 to 200 kPa, or from 10 to 150 kPa.

18: The cured film according to claim 17, wherein the film reaches 30% of the storage modulus increase in less than 1.2 seconds, or less than 1 second.
